(19) United States
(12) Patent Application Publication
(10) Pub. No.: US 2022/0144647 A1
(43) Pub. Date: May 12, 2022

(54) ACTIVATED CARBON MATERIALS, AND METHODS OF PREPARING THEREOF AND USES THEREOF

(71) Applicant: Origin Materials Operating, Inc., West Sacramento, CA (US)

(72) Inventors: Ryan L. SMITH, Sacramento, CA (US); Thomas D. GREGORY, Midland, MI (US); John Albert BISSELL, II, Sacramento, CA (US); Shawn M. BROWNING, West Sacramento, CA (US); Alex B. WOOD, West Sacramento, CA (US); Robert Joseph ARAIZA, West Sacramento, CA (US); Paul J. DORNATH, West Sacramento, CA (US); Alex JOH, West Sacramento, CA (US); Dimitri A. HIRSCH-WEIL, West Sacramento, CA (US); Makoto N. MASUNO, West Sacramento, CA (US)

(73) Assignee: Origin Materials Operating, Inc., West Sacramento, CA (US)

(21) Appl. No.: 17/347,466

(22) Filed: Jun. 14, 2021

Related U.S. Application Data
(63) Continuation of application No. 15/566,638, filed on Oct. 13, 2017, now abandoned.
(60) Provisional application No. 62/148,068, filed on Apr. 15, 2015.

(51) Int. Cl. C01B 32/342; C08G 16/02; C08L 61/00; C08L 97/00; C08K 3/04

(52) U.S. Cl. CPC C01B 32/342; C08G 16/0262; C08L 61/00; C01P 2006/16; C08K 3/04; C01P 2004/32; C08L 97/005

(57) ABSTRACT

Provided is a method of producing activated carbon from a resin composite made up of furanic polymer. The method includes producing a resin composite from feedstock (e.g., in the presence of an acid and a salt), combining the resin composite with a base to form an impregnated material, and carbonizing the impregnated material to produce the and salt activated carbon. Provided herein are also resin composites and activated carbon materials.

### CROSS-REFERENCE TO RELATED APPLICATIONS

This application claims priority to U.S. Provisional Patent Application No. 62/148,068, filed Apr. 15, 2015, which is incorporated herein by reference in its entirety.

### FIELD

The present disclosure relates generally to activated carbon, and more specifically to activated carbon produced from a resin composite that includes furanic polymer (e.g., a furanic resin).

### BACKGROUND

Activated carbon is generally known in the art as a porous carbon material that has been treated, for example, by physical reactivation or chemical activation, to yield a higher surface area. Increased surface area makes the material readily available for adsorption or chemical reactions. Activated carbon may be used in a variety of applications, including purification (such as gas purification, gas scrubbing, water filtration, metal purification and chemical purification) and gas storage. Activated carbon may also be used as super capacitor media, or as solid catalysts for a variety of chemical reactions. What are desired in the art are new methods to produce activated carbon.

### BRIEF SUMMARY

In some aspects, provided are methods of producing activated carbon from a resin composite. Such a resin composite includes furanic polymer, and the resin composite may also be referred to as a furanic resin. In some variations, the resin composite (or furanic resin) may also include non-furanic polymer, in addition to the furanic polymer.

In some variations, the method includes: combining the furanic resin with a base to form an impregnated material, and carbonizing the impregnated material to produce the activated carbon.

In some variations, the furanic resin is produced from feedstock in the presence of an acid. Thus, in one aspect, provided is a method of producing activated carbon by:
a) combining a feedstock and an acid to form a reaction mixture, wherein the acid is HX, wherein X is halo;
b) producing a furanic resin from at least a portion of the reaction mixture;
c) isolating the furanic resin;
d) washing the isolated furanic resin;
e) neutralizing the washed furanic resin;
f) combining the neutralized furanic resin with a base to form an impregnated material; and
g) carbonizing the impregnated material to produce an activated carbon.

In other variations, the furanic resin is produced from feedstock in the presence of an acid and a salt. Thus, in another aspect, provided is a method of producing activated carbon by:
a) combining a feedstock, an acid, and a salt in to form a reaction mixture, wherein:
the acid is HX, wherein X is halo:
the salt is A^{r+}(X⁻)ᵣ, wherein:
   A^{r+} is a Group I or Group II cation, and
   X⁻ is an halo anion; and
b) producing a furanic resin from at least a portion of the reaction mixture;
c) isolating the furanic resin;
d) washing the isolated furanic resin;
e) neutralizing the washed furanic resin; and
f) combining the neutralized furanic resin with a base to form an impregnated material; and
g) carbonizing the impregnated material to produce an activated carbon.

The activated carbon provided herein (e.g., produced from a resin composite according to any of the methods described herein) may be used for gas purification, gas scrubbing, water filtration, metal purification, chemical purification and other purification, for gas storage, for use as super capacitor media, or for use as solid catalysts in a variety of chemical reactions.

In other aspects, provided is a method of producing a resin composite, by:
combining a feedstock, an acid and a salt to form a reaction mixture;
producing a resin composite from at least a portion of the reaction mixture:
isolating the resin composite; and
drying the resin composite.

In some variations, the resin composite produced may be washed and/or neutralized prior to drying.

As discussed above, the resin composite includes a furanic polymer. Thus, in some variations, the resin composite is made up of a plurality of particles, wherein each particle independently is made up of furanic polymer; and salt. In one variation, the salt is incorporated into at least a portion of the particles, or the salt. In another variation, a substantial portion of the salt is present in the interior of the particles. In other variations, the resin composite may also include non-furanic polymers, ash or lignin, or any combinations thereof, and their presence may depend on the feedstock used to produce such resin composite.

### DESCRIPTION OF THE FIGURES

The present application can be understood by reference to the following description taken in conjunction with the accompanying figures.

FIG. 1 depicts an exemplary process to produce activated carbon from a furanic resin (which may also be referred to herein as a resin composite).

FIG. 2 is a scanning electron microscopy (SEM) image of the furanic resin (which may also be referred to herein as a resin composite) used in Examples 2 and 3 described below.

FIG. 3A and FIG. 3B are SEM images of the activated carbon produced in Example 2, where FIG. 3B is a (zoomed in portion of the image in FIG. 3A).

FIGS. 4A and 4B are SEM images of the activated carbon produced in Example 3, where FIG. 4B is a (zoomed in portion of the image in FIG. 4A).

FIGS. 5A-5D depict exemplary processes to produce activated carbon from biomass as a feedstock.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

### Methods of Producing the Activated Carbon

Provided herein are methods of producing activated carbon. Such activated carbon may be used in a variety of applications, including purification (such as gas purification, gas scrubbing, water filtration, metal purification and chemical purification), gas storage, super capacitor media, or as solid catalysts (such as for chemical reactions).

Provided herein is also activated carbon. In some aspects, the activated carbon is a porous carbon material. The activated carbon produced according to the methods has a morphology that allows for good mass transfer for adsorption. In some embodiments, the activated carbon provided has a spherical morphology. Such morphology may improve impregnation of activating agents, while also achieving superior adsorption.

In some aspects, provided is a method of producing activated carbon from a resin composite. Such resin composite includes furanic polymer, and the resin composite may also be referred to as a furanic resin. In some variations, the resin composite may also include non-furanic polymer, in addition to the furanic polymer.

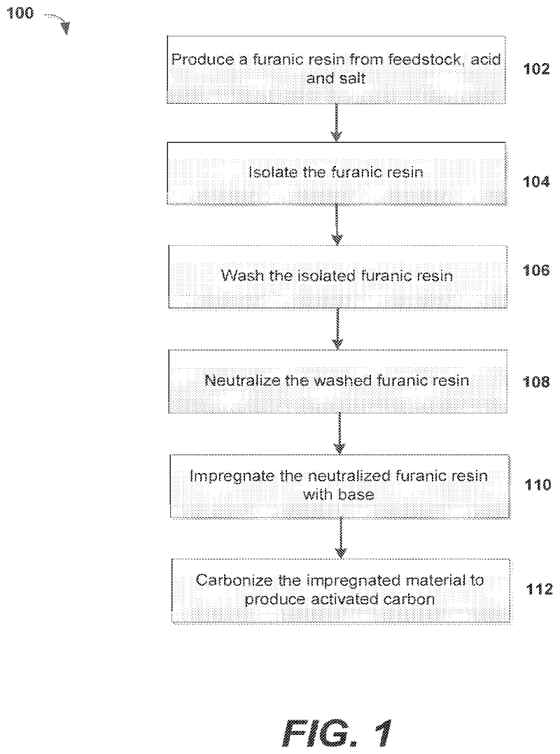

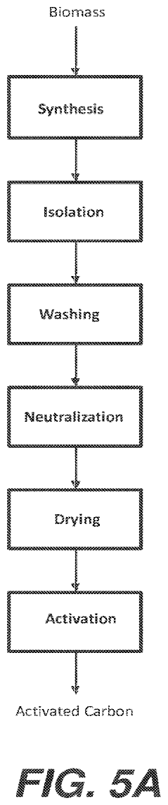

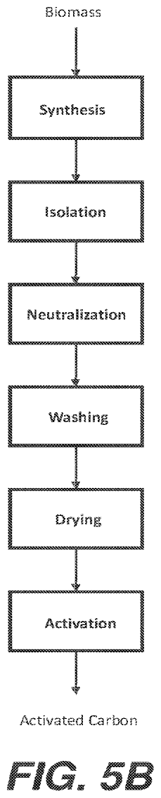

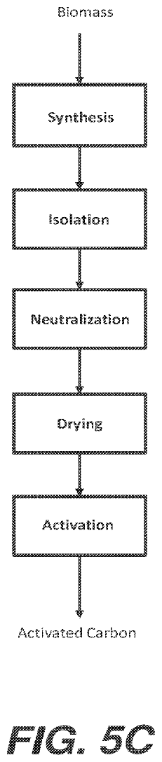

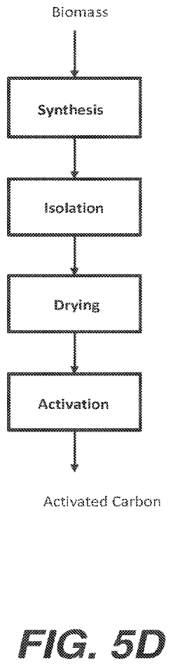

In some embodiments, the methods of producing activated carbon may include: impregnating a resin composite (or furanic resin), and carbonizing the impregnated resin composite (or furanic resin) to produce the activated carbon. For example, with reference to FIG. 1, process 100 is an exemplary process to produce activated carbon from a resin composite (or furanic resin). The steps of exemplary process 100 are described in further detail below. FIGS. 5A-SD also depict exemplary processes to produce activated carbon.

Producing Resin Composite (Also Referred to as Furanic Resin)

Various methods may be employed to produce the resin composite (or furanic resin) that undergoes activation to produce the activated carbon.

In some aspects, provided is a method of producing a resin composite. The resin composite includes furanic polymer, and may also be referred to as furanic resin. In some variations, the resin composite (or furanic resin) is produced by combining a feedstock and an acid. In one variation, the acid is HX, wherein X is halo. The feedstock and acid form a reaction mixture, and the resin composite (or furanic resin) is produced from at least a portion of the reaction mixture. The resin composite (or furanic resin) may be produced when at least a portion of the feedstock in the reaction mixture is reacted with at least a portion of the acid in the reaction mixture. In one example, the resin composite (or furanic resin) may be produced by combining glucose or starch, or a combination thereof, with hydrochloric acid. In certain variations, the hydrochloric acid may be concentrated hydrochloric acid. In certain variations, the resin composite (or furanic resin) may be produced at a temperature of at least 80° C.

In other variations, the resin composite (or furanic resin) is produced by combining a feedstock, an acid, and a salt. In one variation, the acid is HX, wherein X is halo; and the salt is A^{r+}(X⁻)ₜ, wherein A^{r+} is a Group I or Group II cation, and X₋ is a halo anion. For example, the resin composite (or furanic resin) may be produced by combining glucose or starch, or a combination thereof, with hydrochloric acid and calcium chloride. In another example, with reference to FIG. 1, a furanic resin is produced from feedstock, acid and salt in step 102 of exemplary process 100. The feedstock, acid and salt form a reaction mixture, and the furanic resin is produced from at least a portion of the reaction mixture.

In yet other variations, provided is a method of producing a resin composite (or furanic resin), by: combining a feedstock, an acid and a salt to form a reaction mixture; producing a resin composite from at least a portion of the reaction mixture; isolating the resin composite; and drying the resin composite. In certain variations, the method of producing the resin composite further includes washing and/or neutralizing the resin composite produced.

The feedstock, acid, salt, solvents, resin composite, and activated carbon, and the processing conditions to produce the resin composite and activated carbon are described in further detail below.

a) Feedstock

The feedstock used to produce the resin composite (or furanic resin) refers to the starting material to produce the resin composite (or furanic resin). Suitable feedstock may include any materials that contain saccharides. Examples of the feedstock include glucose, glucans, cellulose, hemicellulose, starch, or sucrose, or any mixtures thereof.

In some embodiments, the feedstock may include six-carbon (C6) saccharides. It should be understood that “six-carbon saccharides” or “C6 saccharides” refers to saccharides where the monomeric unit has six carbons. The feedstock may include monosaccharides, disaccharides, polysaccharides, or any mixtures thereof. In one variation, the feedstock includes one or more C6 monosaccharides. In another variation, the feedstock includes a disaccharide or polysaccharide comprising monomeric units having six carbon atoms. It should be understood that the monomeric units may the same or different.

In one embodiment, the feedstock includes a monosaccharide. Examples of suitable monosaccharides include glucose, fructose, and any other isomers thereof. In another embodiment, the feedstock includes a disaccharide. Examples of suitable disaccharides include sucrose. In yet another embodiment, the feedstock includes a polysaccharide. Examples of polysaccharides include cellulose, hemicellulose, cellulose acetate, and chitin. In other embodiments, the feedstock includes a mixture of monosaccharides, disaccharides, polysaccharides. For example, in one variation, the feedstock may include glucose, sucrose, cellulose, or any combinations thereof. In another variation, the feedstock includes glucans, starch, cellulose, or hemicellulose, or any combinations thereof.

In some embodiments, the feedstock includes C6 saccharides selected from glucose, fructose (e.g., high fructose corn syrup), cellobiose, sucrose, lactose, and maltose, or isomers thereof (including any stereoisomers thereof), or any mixtures thereof. In one embodiment, the feedstock includes glucose, or a dimer or polymer thereof, or an isomer thereof. In another embodiment, the feedstock includes fructose, or a dimer or polymer thereof, or an isomer thereof. In another variation, the feedstock is a saccharide composition. For example, the saccharide composition may include a single saccharide or a mixture of saccharides such as fructose, glucose, sucrose, lactose and maltose.

Feedstock suitable for use in producing the resin composite (or furanic resin) may also include derivatives of the sugars described above. In some embodiments, the feedstock may be aldoses, ketoses, or any mixtures thereof. In some embodiments, the feedstock includes C6 aldoses, C6 ketoses, or any mixtures thereof.

In some variations, the feedstock includes an aldose, or any polymers thereof. In one variation, the feedstock includes a C6 aldose, or any polymers thereof. Examples of suitable aldoses include glucose. In another variation, the feedstock includes polyaldoses.

In other variations, the feedstock includes a ketose, or any polymers thereof. In another embodiment, the feedstock includes a C6 ketose, or any polymers thereof. Examples of suitable ketoses include fructose. In another variation, the feedstock includes polyketoses.

In yet another embodiment, the feedstock includes a mixture of C6 aldoses and C6 ketoses. For example, in one variation, the feedstock may include glucose and fructose.

In some embodiments when the feedstock includes sugars, the sugars may be present in open-chain form, cyclic form, or a mixture thereof. One of skill in the art would recognize that, when the feedstock includes glucose, the open-chain form of glucose used may exist in equilibrium with several cyclic isomers in the reaction.

In other embodiments when the feedstock includes sugars, the sugars can exist as any stereoisomers, or as a mixture of stereoisomers. For example, in certain embodiments, the feedstock may include D-glucose, L-glucose, or a mixture thereof. In other embodiments, the feedstock may include D-fructose, L-fructose, or a mixture thereof.

In one variation, the feedstock includes hexose. One of skill in the art would recognize that hexose is a monosaccharide with six carbon atoms, having the chemical formula C₄H₁₂O₆. Hexose may be an aldohexose or a ketohexose, or a mixture thereof. The hexose may be in open-chain form, cyclic form, or a mixture thereof. The hexose may be any stereoisomer, or mixture of stereoisomers. Suitable hexoses may include, for example, glucose, fructose, galactose, mannose, allose, altrose, gulose, idose, talose, psicose, sorbose, and tagatose, or any mixtures thereof.

The feedstock used to produce the resin composite (or furanic resin) may be obtained from any commercially available sources. For example, one of skill in the art would recognize that cellulose and hemicellulose can be found in biomass (e.g., cellulosic biomass or lignocellulosic biomass). In some embodiments, the feedstock is biomass, which can be any plant or plant-derived material made up of organic compounds relatively high in oxygen, such as carbohydrates, and also contain a wide variety of other organic compounds. The biomass may also contain other materials, such as inorganic salts and clays.

Biomass may be pretreated to help make the sugars in the biomass more accessible, by disrupting the crystalline structures of cellulose and hemicellulose and breaking down the lignin structure (if present). Common pretreatments known in the art involve, for example, mechanical treatment (e.g., shredding, pulverizing, grinding), concentrated acid, dilute acid, SO₂, alkali, hydrogen peroxide, wet-oxidation, steam explosion, ammonia fiber explosion (AFEX), supercritical CO₂ explosion, liquid hot water, and organic solvent treatments.

Biomass may originate from various sources. For example, biomass may originate from agricultural materials (e.g., corn kernel, corn cob, corn stover, rice hulls, peanut hulls, and spent grains), processing waste (e.g., paper sludge), and recycled cellulosic materials (e.g., cardboard, old corrugated containers (OCC), old newspaper (ONP), and mixed paper). Other examples of suitable biomass may include wheat straw, paper mill effluent, newsprint, municipal solid wastes, wood chips, saw dust, forest thinnings, slash, miscanthus, switchgrass, sorghum, bagasse, manure, wastewater biosolids, green waste, and food/feed processing residues.

A combination of any of the feedstock described herein may also be used. For example, in one variation, the feedstock may include glucose, corn kernel and wood chips. In another variation, the feedstock may include wood chips and cardboard. In yet another variation, the feedstock may include bagasse and cardboard. In yet another variation, the feedstock may include empty fruit bunches.

b) Acid

In some embodiments of the step to produce the resin composite (or furanic resin), the acid is a halogen-containing acid. Such an acid has a formula HX, wherein X is halo. Any suitable acids that can produce a resin composite (or furanic resin) from the feedstock described herein may be used. In some embodiments, the acid is a halogen-containing mineral acid or a halogen-containing organic acid. A mixture of acids may also be used.

In certain embodiments, the acid may be a chloride acid, or an acid having a chloride ion. In one embodiment, the acid is hydrochloric acid. In other embodiments, the acid may be a bromide acid, or an acid having a bromide ion. In one embodiment, the acid is hydrobromic acid.

The acid used to produce the resin composite (or furanic resin) may be aqueous and/or gaseous. In some embodiments, the acid is an aqueous acid. “Aqueous acid” refers to an acid dissolved, or at least partially dissolved, in water. In certain embodiments, the aqueous acid is hydrochloric acid, hydrobromic acid, nitric acid, phosphoric acid, sulfuric acid, and fluoroboric acid. One of skill in the art would recognize that when nitric acid, phosphoric acid, sulfuric acid, or fluoroboric acid is used, such acid may be employed as one of the reagents to produce an acid of formula HX, wherein X is halo, in situ. In one variation, the acid of formula HX may be provided by reacting an aqueous acid (e.g., nitric acid, phosphoric acid, sulfuric acid, or fluoroboric acid) with a halide salt.

Thus, the acid used herein may be obtained from any commercially available source, or be produced in situ from providing suitable reagents to the reaction mixture. For example, hydrochloric acid may be produced in situ in the reaction mixture by providing sulfuric acid and sodium chloride to the reaction mixture.

In other embodiments, the acid fed into the reactor or the reaction mixture is a gaseous acid. For example, at least a portion of such gaseous acid may be dissolved, or partially dissolved, in the reaction mixture to produce an aqueous acid.

In some embodiments, the acids used in the methods and compositions described herein are organic acids.

In some variations, the acid includes trifluoroacetic acid, oxalic acid, chloroacetic acid, salicylic acid, fumaric acid, citric acid, malic acid, formic acid, lactic acid, acrylic acid, sebacic acid, acetic acid, levulinic acid, carbonic acid, and ammonium chloride. In other variations, the acid includes phosphoric acid, sulfuric acid, nitric acid, or boric acid. In certain embodiments, the acid is phosphoric acid or boric acid.

In some variations, the acid is a weak acid. In some embodiments, the acid has a pKa greater than or equal to −8, or greater than or equal to −5, or greater than or equal to 0. In other variations, the acid has a pKa between −8 and 10, or between 0 and 7, or between 0 and 6, or between 0 and 5. As used herein, the “pKa” of the acid is determined as described in March's Advanced Organic Chemistry: Reactions, Mechanisms, and Structure, 6^{th}, edition.

In other embodiments, the acid has a higher vapor pressure than water, and distillation of the acid and water results in a vapor phase enriched with water, and the loss of acid is also minimized. Thus, in some embodiments of the methods described herein, when the feedstock, acid, salt, and optional solvent are combined to produce 5-(halomethyl)furfural and water, the feedstock, acid, salt, optional solvent, 5-(halomethyl)furfural and water form a mixture. In some variations, when this mixture is distilled, at least a portion of the water is removed, while minimizing the loss of acid in the mixture. In other variations, when this mixture is distilled, at least a portion of the water in the mixture is removed before the acid in the mixture. It should generally be understood that the mixture of the feedstock, acid, salt, optional solvent, 5-(halomethyl)furfural and water may be homogeneous or heterogeneous.

The concentration of the acid used herein may also vary depending on various factors, including the type of feedstock used. In some embodiments, concentrated acid is used. For example, one of skill in the art would recognize that concentrated hydrochloric acid is 12 M. In other embodiments, the acid used to produce the resin composite (or furanic resin) has a concentration less than 12 M, less than or equal to 11.5 M, less than or equal to 11 M, less than or equal to 10.5 M, less than or equal to 10 M, less than or equal to 9.5 M, less than or equal to 9 M, less than or equal to 8.5 M, less than or equal to 8 M, less than or equal to 7.5 M, less than or equal to 7 M, less than or equal to 6.5 M, less than or equal to 6 M, less than or equal to 5.5 M, less than or equal to 5 M, less than or equal to 4.5 M, less than or equal to 4 M, less than or equal to 3.5 M, less than or equal to 3 M, less than or equal to 2.5 M, less than or equal to 2 M, less than or equal to 1.5 M, or less than or equal to 1 M; or between 0.25 M and 10 M, between 0.25 M and 9 M, between 0.25 M and 8 M, between 0.25 M and 7 M, between 0.25 M and 6 M, between 0.25 M and 5 M, between 0.5 M and 10 M, between 0.5 M and 9 M, between 0.5 M and 8 M, between 0.5 M and 7 M, between 0.5 M and 6 M, between 0.5 M and 5 M, between 1 M and 10 M, between 1 M and 9 M, between 1 M and 8 M, between 1 M and 7 M, between 1 M and 6 M, between 1 M and 5 M, between 1 M and 4 M, or between 2 M and 4 M.

The concentration of the acid used herein may also vary depending on various factors, including the type of feedstock used. In some embodiments when the feedstock is or includes an aldose, the acid has a concentration less than 12 M, less than or equal to 11 M, less than or equal to 10 M, less than or equal to 9 M, less than or equal to 8 M, less than or equal to 7 M, less than or equal to 6 M, less than or equal to 5 M, less than or equal to 4 M, less than or equal to 3 M. or less than or equal to 2 M; or between 0.25 M and 11.5 M, between 0.25 M and 10 M, between 0.5 M and 8 M, between 0.5 and 6 M, or between 0.5 and 5 M.

In certain embodiments when the feedstock is or includes glucose, the acid has a concentration less than 12 M, less than or equal to 11 M, less than or equal to 10 M, less than or equal to 9 M, less than or equal to 8 M, less than or equal to 7 M, less than or equal to 6 M, less than or equal to 5 M, less than or equal to 4 M, less than or equal to 3 M, or less than or equal to 2 M; or between 0.25 M and 11.5 M, between 0.25 M and 10 M, between 0.5 M and 8 M, between 0.5 and 6 M, or between 0.5 and 5 M.

In other embodiments when the feedstock is or include ketose, the acid has a concentration less than or equal to 6 M, less than or equal to 5 M, less than or equal to 4 M, less than or equal to 3 M, less than or equal to 2 M, or less than or equal to 1 M; or between 0.25 M and 6 M, between 0.25 M and 5 M, between 0.25 M and 4 M, between 0.25 M and 3 M, between 0.25 M and 2 M, between 0.5 M and 6 M, between 0.5 M and 5 M, between 0.5 M and 4 M, between 0.5 M and 3 M, between 0.5 M and 2 M, between 1 M and 6 M, between 1 M and 5 M, between 1 M and 4 M, between 1 M and 3 M, or between 1 M and 2M.

In other embodiments when the feedstock is or include fructose, the acid has a concentration less than or equal to 6 M, less than or equal to 5 M, less than or equal to 4 M, less than or equal to 3 M, less than or equal to 2 M, or less than or equal to 1 M; or between 0.25 M and 6 M, between 0.25 M and 5 M, between 0.25 M and 4 M, between 0.25 M and 3 M, between 0.25 M and 2 M, between 0.5 M and 6 M, between 0.5 M and 5 M, between 0.5 M and 4 M, between 0.5 M and 3 M, between 0.5 M and 2 M, between 1 M and 6 M, between 1 M and 5 M, between 1 M and 4 M, between 1 M and 3 M, or between 1 M and 2M.

The concentration of acid(s) used to produce the resin composite (or furanic resin) affects the H⁺ concentration in the reaction mixture. In some embodiments, the [H⁺] in the reaction mixture is 12 M, or less than 12 M, less than or equal to 11.5 M, less than or equal to 11 M, less than or equal to 10.5 M, less than or equal to 10 M, less than or equal to 9.5 M, less than or equal to 9 M, less than or equal to 8.5 M, less than or equal to 8 M, less than or equal to 7.5 M, less than or equal to 7 M, less than or equal to 6.5 M, less than or equal to 6 M, less than or equal to 5.5 M, less than or equal to 5 M, less than or equal to 4.5 M, less than or equal to 4 M, less than or equal to 3.5 M, less than or equal to 3 M, less than or equal to 2.5 M, less than or equal to 2 M, less than or equal to 1.5 M, or less than or equal to 1 M; or between 0.25 M and 10 M, between 0.25 M and 9 M, between 0.25 M and 8 M, between 0.25 M and 7 M, between 0.25 M and 6 M, between 0.25 M and 5 M, between 0.5 M and 10 M, between 0.5 M and 9 M, between 0.5 M and 8 M, between 0.5 M and 7 M, between 0.5 M and 6 M, between 0.5 M and 5 M, between 1 M and 10 M, between 1 M and 9 M, between 1 M and 8 M, between 1 M and 7 M, between 1 M and 6 M, between 1 M and 5 M, between 1 M and 4 M, or between 2 M and 4 M.

In certain embodiments, the [H⁺] in the reaction mixture is less than 0.6 M, less than 0.55 M, less than 0.5 M, less than 0.45 M, less than 0.4 M, less than 0.35 M, less than 0.3 M, less than 0.25 M, less than 0.2 M, less than 0.15 M, less than 0.1 M, less than 0.05M, or less than 0.01 M.

It should be understood that the [H⁺] of the reaction mixture may depend on the concentration of acid or acids used to produce the resin composite (or furanic resin). It should also generally be understood that H⁺ is present in sufficient quantities to allow the reaction to proceed (e.g., to produce the resin composite). Thus, in some embodiments, the [H⁺] is greater than 0 M. For example, in some variations, the [H⁺] is greater than or equal to 0.0001 M, 0.001 M, or 0.1 M.

In other embodiments, the [H⁺] in the reaction mixture is between the feedstock concentration and 5 M. The feedstock concentration refers to the molar concentration of C6 monosaccharides, or monomeric units have six carbon atoms.

The acid concentrations as described herein may refer to the initial concentrations, fed concentrations, or steady-state concentrations. Initial concentration refers to the concentration of the reaction mixture at the point in time when the reaction begins. Fed concentration refers to the concentration when the reactants are combined before being fed into the reactor. Steady-state concentration refers to concentration at steady state of the reaction.

In some variations, the acid is added continuously to the reaction mixture at a rate to maintain a non-zero [H⁺]. It should be understood that the acid is consumed in a stoichiometric amount.

c) Salt

In variations of the method where a salt is used in the production of the resin composite (or furanic resin), the salt may be inorganic salts and/or organic salts. An “inorganic salt” refers to a complex of a positively charged species and a negatively charged species, where neither species includes the element carbon. An “organic salt” refers to a complex of a positively charged species and a negatively charged species, where at least one species includes the element carbon.

The selection of the salt used may vary depending on the reaction conditions, as well as the acid and solvent used. In some embodiments, the salt is an inorganic salt. In certain embodiments, the salt is a halogen-containing acid.

In some embodiments, the salt is A^{r+}(X⁻)ᵣ, wherein:
A^{r+} is a Group 1 or Group 11 cation; and
X⁻ is a halo anion.

It should be understood that variable “r” refers to the ionic charge. In certain variations, the salt has a monovalent or divalent cation. In other words, in certain variations, r may be 1 or 2.

Examples of salts that may be used in certain embodiments include lithium salts, sodium salts, potassium salts, rubidium salts, cesium salts, magnesium salts, and calcium salts. In some embodiments, the salt is a lithium salt. In other embodiments, the salt is a calcium salt. In some variations, A^{r+} is Li⁺, Na⁺, K⁺, Rb⁺, Cs⁺, Mg²⁺, Ca²⁺, or Sr²⁺. In certain variations. A^{r+} is Li⁺, Mg²⁺, or Ca⁺. In some variations. X⁻ is Cl⁻ or Br⁻. In certain variations, the salt is LiX, NaX, KX, RbX, CsX, MgX₂, CaX₂, or SrX₂. In one variation, X is Cl or Br. In some variations, the salt is LiCl, NaCl, KCl, RbCl, CsCl, MgCl₂, CaCl₂, SrCl₂, LiBr, NaBr, KBr, RbBr, CsBr, MgBr₂, CaBr₂, or SrBr₂. In certain variations, the salt is selected from LiCl, MgCl₂, CaCl₂, NaCl, KCl, CsCl, LiBr, MgBr₂, NaBr. KBr, and CsBr. In one variation, the salt is LiCl. In another variation, the salt is CaCl₂.

A combination of any of the salts described herein may also be used. For example, in some variations, LiCl and CaCl₂ may be used together as the salt. In other variations, additional salts may also be used. Such additional salts may be selected from, for example, zinc salts, silicate salts, carbonate salts, sulfate salts, sulfide salts, phosphate salts, perchlorate salts, and triflate salts. In certain embodiments, the additional salt is selected from ZnCl₂, lithium triflate (LiOTf), and sodium triflate (NaOTf), or any combination thereof. In one variation, a combination of LiCl and LiOTf is used as the salt.

The concentration of the salt used to produce the resin composite (or furanic resin) may vary. In some embodiments, the concentration of the salt(s) is greater than 5 M, greater than 6 M, greater than 7 M, greater than 8 M, greater than 9 M, or greater than 10 M; or between 5 M and 20 M, between 5 M and 15 M, between 5.5 M and 10 M, between 7 M and 10 M. or between 7.5 M and 9 M; or about 10 M, about 11 M, about 12 M, about 13 M, about 14 M, or about 15 M. In other embodiments, the salt is present from about 0.1% to 50% (w/w) of the aqueous phase.

The concentration of salt(s) and acid(s) used may affects the concentration of the positively charged ions and the negatively charged ions present in the reaction mixture. As discussed above, the salt may be depicted by the formula A^{r+}(X⁻)ᵣ, where A^{r+} is a cation having ionic charge “r”, and X⁻ is a halo anion. The cation concentration present in the reaction mixture may be defined by the following equation:

$$cation concentration = \frac{\vert [ {X}^{-} ] - [ {H}^{+} ] \vert}{valence of cation} ,$$

where X is halo.
It should generally be understood that [H⁺] refers to the H⁺ concentration; and [X⁻] refers to the X⁻ concentration.

In some embodiments, the [X⁻] in the reaction mixture is greater than 2 M, greater than 5 M, greater than 6 M, greater than 7 M, greater than 8 M, greater than 9 M, greater than 10 M; or between 2 M to 25 M, between 5 M and 20 M, between 5 M and 15 M, between 5 M and 12 M, between 6 M and 12 M, between 5.5 M and 10 M, between 7 M and 10 M, between 7.5 M and 9 M, or between 6 M and 12 M; or about 10 M, about 11 M, about 12 M, about 13 M, about 14 M. or about 15 M.

It is understood that any description of acid for use to produce the resin composite (or furanic resin) may be combined with any descriptions of the salts, if present, the same as if each and every combination were individually listed. For example, in some embodiments, the acid is hydrochloric acid, and the salt is lithium chloride, calcium chloride, or a mixture thereof. In one variation, the acid is hydrochloric acid, and the salt is lithium chloride. In another variation, the acid is hydrochloric acid, and the salt is calcium chloride. In yet another variation, the acid is hydrochloric acid, and the salt is a mixture of lithium chloride and calcium chloride. In other variations, the acid is hydrobromic acid, and the salt is lithium bromide and calcium bromide.

It is further understood that any description of acid concentration or [H⁺] in the step to produce the resin composite (or furanic resin) may be combined with any description of the salt concentration or [X⁻] the same as if each and every combination were individually listed. In some embodiments, the [H⁺] in the reaction mixture is greater than 0 M and less than 8M; and the [X⁻] in the reaction mixture is at least 5 M. In other embodiments, the [H⁺] in the reaction mixture is greater than 0 M and less than 8M; and the [X−] in the reaction mixture is at least 10 M.

For example, in other embodiments where the acid is hydrochloric acid and the salt is lithium chloride, the hydrochloric acid concentration is between 0.5 M and 9 M, and the lithium chloride concentration is between 5M and 20 M. In one variation, the hydrochloric acid concentration is between 0.5 M and 6 M, and the lithium chloride concentration is about 12 M. In other embodiments where the acid is hydrochloric acid, and the salt is lithium chloride, calcium chloride, or a mixture thereof, the reaction mixture has a [H⁺] between 0.5 M and 9 M. and a [Cl⁻] between 5M and 20 M. In one variation, the reaction mixture has a [H⁺] between 0.5 M and 6 M, and the reaction mixture has a [Cl⁻] of about 12 M.

The salt used herein may be obtained from any commercially available source, or be produced in situ from providing suitable reagents to the reaction mixture. For example, certain reagents in the presence of hydrochloric acid may undergo ion exchange to produce the chloride salt used to produce the resin composite (or furanic resin).

The concentrations described herein for the salt or [X⁻] (e.g., [Cl⁻]) may refer to either initial concentrations, fed concentrations or steady-state concentrations.

d) Solvent

While step 102 of exemplary process 100 (FIG. 1) is performed neat (i.e., without the use of any solvents), in some variations of process 100, a solvent may be used. The solvent used in producing the resin composite (or furanic resin) may also be referred to as the “reaction solvent”. Thus, in some variations, a resin composite (or furanic resin) is produced by combining a feedstock, an acid, a salt, and solvent. The solvent may be obtained from any source, including any commercially available sources.

Any suitable solvent that can form a liquid/liquid biphase in the reaction mixture may be used, such that one phase is predominantly an organic phase and a separate phase is predominantly an aqueous phase.

The solvent used to produce the resin composite (or furanic resin) may also be selected based on dipole moment. One of skill in the art would understand that the dipole moment is a measure of polarity of a solvent. The dipole moment of a liquid can be measured with a dipole meter. In some embodiments, the solvent used herein has a dipole moment less than 20.1 D, less than or equal to 20 D, less than or equal to 18 D, or less than or equal to 15 D.

The solvent used to produce the resin composite (or furanic resin) may also be selected based on boiling point. In some embodiments, the solvent has a boiling point of at least 110° C., at least 150° C., or at least 240° C.

The solvent may include one solvent or a mixture of solvents. For example, in some embodiments, the solvent includes one or more alkyl phenyl solvents, one or more alkyl solvents (e.g., heavy alkyl solvents), one or more ester solvents, one or more aromatic solvents, one or more silicone oils, or any combinations or mixtures thereof. In other embodiments, the solvent includes one or more hydrocarbons, one or more halogenated hydrocarbons, one or more ethers, one or more halogenated ethers, one or more cyclic ethers, one or more amides, one or more silicone oils, or any combinations or mixtures thereof.

In some embodiments, the solvent includes para-xylene, mesitylene, naphthalene, anthracene, toluene, dodecylbenzene, pentylbenzene, hexylbenzene, and other alkyl benzenes (e.g., Wibaryl® A, Wibaryl® B, Wibaryl® AB, Wibaryl® F, Wibaryl® R. Cepsa Petrepar® 550-Q, Cepsa Petrepar® 900-Q, Santovac® 5, Santovac® 7, Marlican®, Synnaph AB 3, Synnaph AB4), sulfolane, hexadecane, heptadecane, octadecane, icosane, heneicosane, docosane, tricosane, tetracosane, or any combinations or mixtures thereof.

It should be understood that the solvent may fall into one or more of the classes listed herein. For example, the solvent may include para-xylene, which is an alkyl phenyl solvent and an aromatic solvent.

Alkyl Phenyl Solvents

As used herein, “an alkyl phenyl solvent” refers to a class of solvents that may have one or more alkyl chains and one or more phenyl or phenyl-containing ring systems. The alkyl phenyl solvent may be referred to as an alkylbenzene or a phenylalkane. One skilled in the art would recognize that certain phenylalkanes may also be interchangeably referred to as an alkylbenzene. For example, (1-phenyl)pentane and pentylbenzene refer to the same solvent.

In some embodiments, the solvent includes an alkylbenzene. Examples may include (monoalkyl)benzenes, (dialkyl)benzenes, and (polyalkyl)benzenes. In certain embodiments, the alkylbenzene has one alkyl chain attached to one benzene ring. The alkyl chain may have one or two points of attachment to the benzene ring. Examples of alkylbenzenes with one alkyl chain having one point of attachment to the benzene ring include pentylbenzene, hexylbenzene and dodecylbenzene. In embodiments where the alkyl chain has two points of attachment to the benzene ring, the alkyl chain may form a fused cycloalkyl ring to the benzene. Examples of alkylbenzenes with one alkyl having two points of attachment to the benzene ring include tetralin. It should be understood that the fused cycloalkyl ring may be further substituted with one or more alkyl rings.

In other embodiments, the alkylbenzene has two or more alkyl chains (e.g., 2, 3, 4, 5, or 6 alkyl chains) attached to one benzene ring.

In yet other embodiments, the alkylbenzene is an alkyl-substituted fused benzene ring system. The fused benzene ring system may include benzene fused with one or more heterocyclic rings. In one embodiment, the fused benzene ring system may be two or more fused benzene rings, such as naphthalene. The fused benzene ring system may be optionally substituted by one or more alkyl chains.

In some embodiments, the solvent includes phenylalkane. Examples may include (monophenyl)alkanes, (diphenyl)alkanes, and (polyphenyl)alkanes. In certain embodiments, the phenylalkane has one phenyl ring attached to one alkyl chain. The phenyl ring may be attached to any carbon along the alkyl chain. For example, the phenyl alkyl having one alkyl chain may be (l-phenyl)pentane, (2-phenyl)pentane, (I-phenyl)hexane, (2-phenyl)hexane. (3-phenyl)hexane, (1-phenyl)dodecane, and (2-phenyl)dodecane.

In other embodiments, the phenylalkane has two or more phenyl rings attached to one alkyl chain.

In one embodiment, the solvent includes Wibaryl® A, Wibaryl® B, Wibaryl® AB, Wibaryl® F, Wibaryl® R, Cepsa Petrepar® 550-Q, or any combinations or mixtures thereof. In another embodiment, the solvent includes para-xylene, toluene, or any combinations or mixtures thereof.

In certain embodiments, the alkyl chain of a solvent may be 1 to 20 carbon atoms (e.g., C₁₋₂₀ alkyl). In one embodiment, the alkyl chain may be 4 to 15 carbons (e.g., C₄₋₁₅ alkyl), or 10 to 13 carbons (e.g., C₁₀₋₁₃ alkyl). The alkyl chain may be linear or branched. Linear alkyl chains may include, for example, n-propyl, n-butyl, n-hexyl, n-heptyl, n-octyl, n-nonanyl, n-decyl, n-undecyl, and n-dodecyl. Branched alkyl chains may include, for example, isopropyl, sec-butyl, isobutyl, tert-butyl, and neopentyl. In some embodiments where the solvent includes two or more alkyl chains, certain alkyl chains may be linear, whereas other alkyl chains may be branched. In other embodiments where the solvent includes two or more alkyl chains, all the alkyl chains may be linear or all the alkyl chains may be branched.

For example, the solvent includes a linear alkylbenzene (“LAB”). Linear alkylbenzenes are a class of solvents having the formula C₆H₅CₙH₂ₙ₊₁. For example, in one embodiment, the linear alkylbenzene is dodecylbenzene. Dodecylbenzene is commercially available, and may be “hard type” or “soft type”. Hard type dodecylbenzene is a mixture of branched chain isomers. Soft type dodecylbenzene is a mixture of linear chain isomers. In one embodiment, the solvent includes a hard type dodecylbenzene.

In some embodiments, the solvent includes any of the alkyl phenyl solvents described above, in which the phenyl ring is substituted with one or more halogen atoms. In certain embodiments, the solvent includes an alkyl(halobenzene). For example, the alkyl(halobenzene) may include alkyl(chlorobenzene). In one embodiment, the halo substituent for the phenyl ring may be, for example, chloro, bromo, or any combination thereof.

In other embodiments, the solvent includes naphthalene, naphthenic oil, alkylated naphthalene, diphenyl, polychlorinated biphenyls, polycyclic aromatic hydrocarbons, or halogenated hydrocarbons.

Aliphatic Solvents

In one embodiment, the solvent includes an aliphatic solvent. The aliphatic solvent may be linear, branched, or cyclic. The aliphatic solvent may also be saturated (e.g., alkane) or unsaturated (e.g., alkene or alkyne). In some embodiments, the solvent includes a C1-C20 aliphatic solvent, a C1-C10, aliphatic solvent, or a C1-C6 aliphatic solvent. In certain embodiments, the solvent includes a C4-C30 aliphatic solvent, a C6-C30 aliphatic solvent, a C6-C24 aliphatic solvent, or a C6-C20 aliphatic solvent. In certain embodiments, the solvent includes C8+ alkyl solvent, or a C8-C50 alkyl solvent, a C8-C40 alkyl solvent, a C8-C30 alkyl solvent, a C8-C20 alkyl solvent, or a C8-C16 alkyl solvent. Suitable aliphatic solvents may include, for example, butane, pentane, cyclopentane, hexane, cyclohexane, heptane, cycloheptane, octane, cyclooctane, nonane, decane, undecane, dodecane, hexadecane, or any combinations or mixtures thereof. In certain embodiments, the aliphatic solvent is linear.

The aliphatic solvent may be obtained from petroleum refining aliphatic fractions, including any isomers of the aliphatic solvents, and any mixtures thereof. For example, alkane solvents may be obtained from petroleum refining alkane fractions, including any isomers of the alkane solvents, and any mixtures thereof. In certain embodiments, the solvent includes petroleum refining alkane fractions.

Aromatic Solvents

In another embodiment, the solvent includes an aromatic solvent. In some embodiments, the solvent includes a C6-C20 aromatic solvent, a C6-C12 aromatic solvent, or a C13-C20 aromatic solvent. The aromatic solvent may be optionally substituted. Suitable aromatic solvents may include, for example, para-xylene, mesitylene, naphthalene, anthracene, toluene, anisole, nitrobenzene, bromobenzene, chlorobenzene (including, for example, dichlorobenzene), dimethylfuran (including, for example, 2,5-dimethylfuran), and methylpyrrole (including, for example, N-methylpyrrole).

Ether Solvents

In other embodiments, the solvent includes an ether solvent, which refers to a solvent having at least one ether group. For example, the solvent includes a C2-C20 ether, or a C2-C10 ether. The ether solvent can be non-cyclic or cyclic. For example, the ether solvent may be alkyl ether (e.g., diethyl ether, glycol dimethyl ether (glyme), diethylene glycol dimethyl ether (diglyme), or triethylene glycol dimethyl ether (triglyme)). In another example, the ether solvent may be cyclic, such as dioxane (e.g., 1,4-dioxane), dioxin, tetrahydrofuran, or a cycloalkyl alkyl ether (e.g., cyclopentyl methyl ether).

The solvent may include an acetal such as dioxolane (e.g., 1,3-dioxolane).

The solvent may also include a polyether with two or more oxygen atoms. In some embodiments, the ether solvent has a formula as follows:

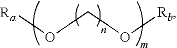

wherein each Rₐ and R_{b} is independently aliphatic moieties, and n and m are integers equal to greater than 1. In some embodiments, each Rₐ and R_{b} is independently alkyl. In certain embodiments, each Rₐ and R_{b} is independently C1-C10 alkyl, or C1-C6 alkyl. Rₐ and R_{b} may be the same or different. In other embodiments, each n and m are independently 1 to 10, or 1 to 6, where n and m may be the same or different.

The formula above includes proglymes (such as dipropylene glycol dimethylether), or glymes (such as glycol diethers based on ethylene oxide). In one embodiment, the solvent includes glyme, diglyme, triglyme, or tetraglyme.

It should also be understood that a solvent having an ether group may also have one or more other functional groups. It should be understood, however, that the solvent may have an ether functional group in combination with one or more additional functional groups, such as alcohols. For example, the solvent includes alkylene glycols (e.g., ethylene glycol, diethylene glycol, triethylene glycol, polyethylene glycol), phenyl ethers (e.g., diphenyl ether, polyphenyl ethers), or alkylphenylethers (e.g., alkyldiphenyl ether). For example, in some variations, the solvent includes a DOWTHERM™ solvent, such as DOWTHERM™ G.

In certain embodiments, the solvent includes a polyphenyl ether that includes at least one phenoxy or at least one thiophenoxy moiety as the repeating group in ether linkages. For example, in one embodiment, the solvent includes Santovac.

Ester Solvents

In yet other embodiments, the solvent includes an ester solvent, which refers to a solvent having at least one ester group. For example, the solvent includes a C2-C20 ester, or a C2-C10 ester. The ester solvent can be non-cyclic (linear or branched) or cyclic. For example, non-cyclic ester solvents may include alkyl acetate (e.g., methyl acetate, ethyl acetate, propyl acetate, butyl acetate), triacetin, and dibutylphthalate. An example of cyclic ester is, for example, propylene carbonate. It should be understood, however, that a solvent having an ester group may also have one or more other functional groups. The ester solvent may also include alkyl lactate (e.g., methyl lactate, ethyl lactate, propyl lactate, butyl lactate), which has both an ester group as well as a hydroxyl group.

Halogenated Solvents

In yet other embodiments, the solvent includes halogenated solvents. For example, the solvent can be a chlorinated solvent. Suitable chlorinated solvents may include, for example, carbon tetrachloride, chloroform, methylene chloride, bromobenzene and dichlorobenzene.

Other Solvents

In some variations, the solvent includes water.

A combination or mixture of solvents may also be used to produce the resin composite (or furanic resin). In some embodiments, an ether solvent may be combined with one or more other types of solvents listed above.

The solvents used to produce the resin composite (or furanic resin) may vary depending on the type and amount of feedstock used. For example, in some embodiments, the mass to volume ratio of feedstock to solvent is between 1 g and 30 g feedstock per 100 mL solvent.

It is further understood that any description of the solvents used to produce the resin composite (or furanic resin) may be combined with any description of the acids and salts the same as if each and every combination were individually listed. For example, in some embodiments, the acid is hydrochloric acid, the salt is lithium chloride or calcium chloride, or a combination thereof, and the solvent is an alkyl phenyl solvent.

e) Reaction Conditions

As used herein, “reaction temperature” and “reaction pressure” refer to the temperature and pressure, respectively, at which the reaction takes place to produce a resin composite (or furanic resin).

In some embodiments of the step to produce the resin composite (or furanic resin), the reaction temperature is at least 15° C., at least 25° C., at least 30° C., at least 40° C., at least 50° C., at least 60° C., at least 70° C., at least 80° C., at least 90° C., at least 100° C., at least 110° C., at least 115° C., at least 120° C., at least 125° C., at least 130° C., at least 135° C., at least 140° C., at least 145° C., at least 150° C., at least 175° C., at least 200° C., at least 250° C., or at least 300° C. In other embodiments, the reaction temperature is between 110° C. and 300° C., between 110° C. to 250° C., between 150° C. and 300° C., or between 110° C. and 250° C.

In some embodiments of the step to produce the resin composite (or furanic resin), the reaction pressure is between 0.1 atm and 10 atm. In other embodiments, the reaction pressure is atmospheric pressure.

It should be understood that temperature may be expressed as degrees Celsius (° C.) or Kelvin (K). One of ordinary skill in the art would be able to convert the temperature described herein from one unit to another. Pressure may also be expressed as gauge pressure (barg), which refers to the pressure in bars above ambient or atmospheric pressure. Pressure may also be expressed as bar, atmosphere (atm), pascal (Pa) or pound-force per square inch (psi). One of ordinary skill in the art would be able to convert the pressure described herein from one unit to another.

The reaction temperature and reaction pressure of the step to produce the resin composite (or furanic resin) may also be expressed as a relationship. For example, in one variation, reaction temperature T expressed in Kelvin and reaction pressure P expressed in psi, wherein 10<Ln[P/(1 psi)]+2702/(T/(1 K))<13.

The residence time will also vary with the reaction conditions and desired yield. Residence time refers to the average amount of time it takes to produce a resin composite (or furanic resin) from the reaction mixture. In some variations of the step to produce the resin composite (or furanic resin), the residence time is at least 360 minutes, at least 240 minutes, at least 120 minutes, at least 60 minutes, at least 30 minutes, at least 20 minutes, at least 10 minutes, at least 5 minutes, or at least 2 minutes.

Isolating

In some variations, provided is method of producing a resin composite, by: combining a feedstock, an acid and a salt to form a reaction mixture; producing a resin composite from at least a portion of the reaction mixture; and isolating the resin composite. As discussed above, the resin composite includes furanic polymer, and may also be referred to as a resin composite. With reference again to FIG. 1, the furanic resin produced is isolated in step 104. Any suitable techniques known in the art may be employed to isolate the furanic resin, such as filtration and centrifugation. For example, solid-liquid separation techniques such as filtration and centrifugation may be used to isolate the furanic resin produced. With reference to FIGS. 5A-5D, the resin composite is produced after synthesis, and prior to washing, neutralization and drying (if present).

Drying

With reference to FIG. 5D, the resin composite is synthesized, isolated and then dried prior to activation. Thus, in some variations, provided is method of producing a resin composite, by: combining a feedstock, an acid and a salt to form a reaction mixture; producing a resin composite from at least a portion of the reaction mixture; isolating the resin composite; and drying the resin composite.

Drying may be used to remove at least a portion of the water from the resin composite produced. In one variation, the resin composite obtained after drying has less than 90%, less than 80%, less than 70%, less than 60%, less than 50%, less than 40%, less than 30%, less than 20%, less than 10%, less than 9%, less than 8%, less than 7%, less than 6%, less than 5%, less than 4%, less than 3%, less than 2%, less than 1%, less than 0.9%, less than 0.8%, less than 0.7%, less than 0.6%, less than 0.5%, less than 0.4%, less than or 0.3%, less than 0.2%, or less than 0.1% by weight water (or moisture). In other variations, the resin composite obtained after drying has between 50% and 90%, or between 50% and 80% by weight water (or moisture).

In some embodiments of the methods to produce the resin composite, the resin composite is dried to remove at least a portion of water so as to allow for impregnation via a solution of activating agent, as described herein. It was unexpectedly observed, however, that the resin composite could be dried to a point at which the dried resin composite could not be re-hydrated to the original water absorption capacity. In certain embodiments (e.g., where the resin composite is used to produce an activated carbon), it is desirable to obtain a resin composite material that can be re-hydrated to its original water absorption capacity.

In some variations, the dried resin composite has a water absorption capacity of at least 2 g, at least 3 g, at least 4 g, at least 5 g, at least 6 g, at least 7 g, or at least 8 g of water/g resin composite; or between 2 g and 9 g of water/g resin composite. In other variations, the resin composite is dried to a point at which the water absorption capacity of the resin composite drops below 0.25 g, 0.5 g, 0.75 g, 1 g, 1.5 g, or 2 g of water/g resin composite. In a variation of the foregoing, water absorption capacity of the resin composite refers to the amount of water in grams contained or held by the resin composite per gram of resin composite.

Drying may also be used to remove at least a portion of the other volatile compounds that may be present in the resin composite produced. Such volatile compounds may include, for example, acid and solvent used in the process for producing the resin composite (including in the synthesis or neutralization steps). In some variations, the resin composite obtained after drying has less than 10%, less than 9%, less than 8%, less than 7%, less than 6%, less than 5%, less than 4%, less than 3%, less than 2%, less than 1%, less than 0.9%, less than 0.8%, less than 0.7%, less than 0.6%, less than 0.5%, less than 0.4%, less than or 0.3%, less than 0.2%, or less than 0.1% by weight volatile compounds.

Drying may be performed using any suitable methods or techniques and any suitable equipment known in art. Further, industrial drying equipment may be used to dry the resin composite. Examples may include a rotary dryer, a tube furnace, or an oven.

Drying may be performed at different temperatures and/or for different amounts of time. In certain variations, drying is performed at a temperature less than 250° C.; or between 40° C. and 250° C., between 100° C. and 250° C., or between 100° C. and 150° C.

In some variations, the resin composite is in the form of powder (e.g., after drying).

Washing

The washing of the isolated resin composite is an optional step. In some variations, provided is a method of producing a resin composite, by: combining a feedstock, an acid and a salt to form a reaction mixture; producing a resin composite from at least a portion of the reaction mixture; isolating the resin composite; washing the isolated resin composite; and drying the washed resin composite. As discussed above, the resin composite includes furanic polymer, and may also be referred to as a resin composite.

With reference again to FIG. 1, the isolated furanic resin is washed in step 106. The solvent used to wash the isolated resin composite (or furanic resin) may also be referred to as the “wash solvent”.

In some variations of the methods described herein, the wash solvent may be same as the solvent used in the reaction to produce the activated carbon from the resin composite (or furanic resin). In other variations, the wash solvent is different from the solvent used in the reaction to produce the activated carbon from the resin composite (or furanic resin).

Any suitable solvents may be used to wash the isolated resin composite (or furanic resin). For example, in some variations, the wash solvent includes an organic solvent. In certain variations, the wash solvent includes an organic solvent having a boiling point below 160° C.

Solvents used to produce the resin composite, as described above, may be used to wash the resin composite. In certain variations, the wash solvent includes an aromatic solvent. In one variation, the wash solvent includes an alkyl phenyl solvent. In one embodiment, the wash solvent includes a linear alkylbenzene. In another embodiment, the solvent includes an alkyl(halobenzene). In certain embodiments of the foregoing, the alkyl chain may be 1 to 20 carbon atoms (e.g., C₁₋₂₀ alkyl). In one embodiment, the alkyl chain may be 4 to 15 carbons (e.g., C₄₋₁₅ alkyl), or 10 to 13 carbons (e.g., C₁₀₋₁₃ alkyl). The alkyl chain may be linear or branched. For example, in some variations, the wash solvent includes Wibaryl® A, Wibaryl® B, Wibaryl® AB, Wibaryl® F, Wibaryl® R, Cepsa Petrepar® 550-Q, or any combinations or mixtures thereof. In another embodiment, the wash solvent includes toluene.

In other variations, the wash solvent includes a phenyl ether (e.g., diphenyl ether, polyphenyl ethers), or an alkylphenylether (e.g., alkyldiphenyl ether). For example, in some variations, the wash solvent includes a DOWTHERM™ solvent, such as DOWTHERM™ G.

In other variations, the resin composite may be washed with brine. Washing with brine can help to move any residual acid that may be present in the resin composite. For example, in one variation, the isolated resin composite may be washed with brine made up of calcium chloride to remove hydrochloric acid that may be present in the resin composite.

The brine may include the same salt used to produce the resin composite, or a different salt. In certain variations, the brine comprises a salt of formula A^{r+}(X⁻)ᵣ, wherein A^{r+} is a Group I or Group II cation, and X⁻ is a halo anion. Examples of salts that may be used include lithium salts, sodium salts, potassium salts, rubidium salts, cesium salts, magnesium salts, and calcium salts. In some embodiments, the salt is a lithium salt. In other embodiments, the salt is a calcium salt. In some variations, A^{r+} is Li⁺, Na⁺, K⁺, Rb⁺, Cs⁺, Mg²⁺, Ca²⁺, or Sr²⁺. In certain variations. A^{r+} is Li⁺, Mg²⁺, or Ca²⁺. In some variations, X⁻ is Cl⁻ or Br⁻. In certain variations, the salt is LiX, NaX, KX, RbX, CsX, MgX₂, CaX₂, or SrX₂. In one variation, X is Cl or Br. In some variations, the salt is LiCl, NaCl, KCl, RbCl, CsCl, MgCl₂, CaCl₂, SrCl₂, LiBr, NaBr, KBr, RbBr, CsBr, MgBr₂, CaBr₂, or SrBr₂. In certain variations, the salt is selected from LiCl, MgCl₂, CaCl₂, NaCl, KCl, CsCl, LiBr, MgBr₂, NaBr, KBr, and CsBr. In one variation, the salt is LiCl. In another variation, the salt is CaCl₂.

A combination of any of the salts described herein may also be used in the brine. For example, in some variations, LiCl and CaCl₂ may be used together in the brine. In other variations, additional salts may also be used in the brine. Such additional salts may be selected from, for example, zinc salts, silicate salts, carbonate salts, sulfate salts, sulfide salts, phosphate salts, perchlorate salts, and triflate salts. In certain embodiments, the additional salt used in the brine is selected from ZnCl₂, lithium triflate (LiOTf), and sodium triflate (NaOTf), or any combination thereof.

In yet other variations, the resin composite may be washed with water. For example, deionized water may be used to wash the resin composite. Washing the isolated resin composite with water can change the salt content and pH of the resin composite. For example, in certain variations, the isolated resin composite is washed with water to remove at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, or at least 90% by weight of salt present in the isolated resin composite. In certain variations, the isolated composite is washed to achieve a pH1 of between 4 and 8, or between 4 and 6, or between 6 and 8.

The resin composite may be washed by one or multiple washes (e.g., using organic solvent, brine and/or water).

Any combination or mixture of the wash solvents (including, for example, organic solvent, brine and water) described herein may also be used.

Further, with respect to step 106, any suitable methods or techniques may be employed to wash the furanic resin. For example, when the resin composite (or furanic resin) is combined with the wash solvent, a slurry will typically form. In some variations, the slurry may be viscous. One of skill in the art would recognize that a motorized stirrer may be employed to mix the slurry. The slurry may then be filtered, for example, by vacuum filtration or other suitable filtration techniques, to isolate the washed resin composite (or furanic resin).

Washing may be performed using any suitable methods or techniques known in the art. For example, washing may be accomplished by spraying or rinsing; or contacting the resin composite (or furanic resin) with the wash solution, and then isolating the washed resin composite (or furanic resin) by filtration or centrifugation.

Neutralizing

The neutralizing of the isolated resin composite is an optional step. The resin composite may be neutralized before drying, with or without a washing step.

For example, in one variation, with reference again to FIG. 1, the washed furanic resin is then neutralized in step 108. In another example, with reference to FIG. 5A, the resin composite is synthesized, isolated, washed, neutralized, and then dried prior to activation. Thus, in some variations, provided is a method of producing a resin composite, by: combining a feedstock, an acid and a salt to form a reaction mixture; producing a resin composite from at least a portion of the reaction mixture; isolating the resin composite; washing the isolated resin composite; neutralizing the washed resin composite; and drying the neutralized resin composite.

With reference to FIG. 5B, the resin composite is synthesized, isolated, neutralized, washed, and then dried prior to activation. Thus, in other variations, provided is a method of producing a resin composite, by: combining a feedstock, an acid and a salt to form a reaction mixture; producing a resin composite from at least a portion of the reaction mixture; isolating the resin composite; neutralizing the isolated resin composite; washing the neutralized resin composite; and drying the washed resin composite.

With reference to FIG. 5C, the resin composite is synthesized, isolated, neutralized, and then dried prior to activation. Similarly, with reference to FIG. 1, the isolated furanic resin is neutralized following isolation and before drying in step. Thus, in certain variations, provided is a method of producing a resin composite, by: combining a feedstock, an acid and a salt to form a reaction mixture; producing a resin composite from at least a portion of the reaction mixture; isolating the resin composite; neutralizing the isolated resin composite; and drying the neutralized resin composite.

Any suitable solutions may be used to neutralize the isolated resin composite. For example, the resin composite may be neutralized using a basic solution, an acid solution, or both. In some variations, the neutralized resin composite has a pH between 6 and 8.

In some instances, the resin composite produced may be acidic, and can be neutralized using a base. Suitable bases may include, for example, NaOH, CaCO₃, NaHCO, and KHCO₃. Any combinations of the bases described herein may also be used.

In some variations of the methods described herein, the neutralization of the isolated resin composite is performed by contacting the isolated resin composite with a basic solution. Any suitable basic solutions may be used to neutralize the isolated resin composite. For example, in some variations, the basic solution is a hydroxide solution. The hydroxide solution may be prepared, for example, using potassium hydroxide or sodium hydroxide. In other variations, the basic solution is a carbonate solution. The carbonate solution may be prepared, for example, from calcium carbonate. In other variations, the basic solution is a bicarbonate solution. The bicarbonate solution may be prepared, for example, from sodium bicarbonate or potassium bicarbonate.

Activating

The resin composite is activated to produce the activated carbon described herein. The resin composite described herein may be activated by using activating agents and by heating.

With reference to FIGS. 5A-5D, the resin composite is synthesized, isolated, optionally washed and/or neutralized, and then dried prior to activation. In some embodiments of the methods to produce activated carbon, the resin composite may be dried prior to chemical and/or thermal activation. Thus, in some variations, provided is a method of producing activated carbon, by: providing any of the resin composites described herein; drying the resin composite; contacting the dried resin composite with an activating agent to form an impregnated material; and heating the impregnated material to produce the activated carbon. Any suitable methods to dry the impregnated material may be employed.

With reference to FIG. 1, in some variations, process 100 may include one or more additional steps to treat the furanic resin prior to activation. For example, in one variation, after step 108 and before step 110, the neutralized furanic resin may be dried before combining with the base to impregnate the furanic resin. Thus, in one variation of the methods to produce activated carbon, provided is a method of producing activated carbon, by: providing any of the resin composites described herein; neutralizing the resin composite; drying the neutralized resin composite; contacting the dried resin with an activating agent to form an impregnated material; and heating the impregnated material to produce the activated carbon.

a) Impregnating

Thus, in some aspects, provided is a method of producing activated carbon, by: contacting any of the resin composites described herein with an activating agent to form an impregnated material; and heating the impregnated material to produce the activated carbon.

The resin composites may be impregnated with activating agents. As discussed above, the resin composite includes furanic polymer, and may also be referred to as furanic resin. In one variation, with reference to FIG. 1, the neutralized furanic resin undergoes chemical activation by impregnation with a chemical. The neutralized furanic resin is impregnated with a base in step 110.

In some embodiments of the methods to produce activated carbon, the activating agent is a base. In certain variations, the base is an Arrhenius base. In certain variations, the base is a strong base. Suitable bases may include, for example, sodium hydroxide, potassium hydroxide, or calcium hydroxide. Any combination of bases may also be used. In step 110, the base may be combined with the neutralized furanic resin as an aqueous solution.

In other embodiments of the methods to produce activated carbon, the activating agent is an acid. Suitable acids may include, for example, phosphoric acid and sulfuric acid.

In yet other embodiments of the methods to produce activated carbon, the activating agent includes a metal halide. In one variation, the metal halide is a metal chloride. For example, suitable metal halides include calcium chloride and zinc chloride.

In yet other embodiments of the methods to produce activated carbon, the activating agent includes urea.

Any suitable combinations of the activating agents described herein may be used. For example, a combination of a chloride salt and urea may be used as the activating agents. In one variation, zinc chloride and urea may be used. In another variation, calcium chloride and urea may be used.

The amount of activating agent used may vary. Various factors may impact the amount of activating used, including, for example, the visco-elasticity of the isolated resin composite. The amount of activating agent used may be measured relative to the amount of resin composite. Thus, in some variations, the resin composite to activating agent ratio is between 0.5:1 and 5:1, or between 1:2 and 3:1; or less than 1:2. In one variation, the resin composite to activating agent ratio is between 1:0.1 and 1:2, or between 1:0.4 and 1:2.

b) Heating/Carbonizing

The impregnated material may be heated to further activate and/or carbonize the material to produce the activated carbon. In some variations, the impregnated material undergoes thermal treatment and is heated to a suitable temperature to increase the porosity of the resulting activated carbon.

For example, with reference again to FIG. 1, the impregnated material is carbonized to produce activated carbon in step 112. In some variations, the impregnated material is heated to a temperature of at least 400° C., at least 500° C., at least 600° C., at least 700° C., at least 800° C., at least 900° C., or at least 1000° C.; or between 400° C. and 1200° C., between 400° C. and 1100° C., between 400° C. and 1000° C., between 400° C. and 900° C., between 400° C. and 800° C., between 450° C. and 850° C., between 500° C. and 1200° C., between 500° C. and 1100° C., between 500° C. and 1000° C., between 500° C. and 900° C., between 500° C. and 800° C., between 600° C. and 1200° C., between 600° C. and 1100° C., between 600° C. and 1000° C., between 600° C. and 900° C., between 600° C. and 800° C., or between 700° C. and 900° C., between 800° C. and 900° C., or between 1000° C. and 1200° C. In some variations, the impregnated material is carbonized in an inert atmosphere, for example, with argon or nitrogen. It should be understood, however, that, in some variations, the argon or nitrogen atmosphere may have trace quantities of oxygen.

c) Additional Processing Steps

The activated carbon produced may undergo one or more additional processing steps. For example, in some embodiments, the activated carbon produced may be washed. In one variation, the activated carbon produced may be washed with an acid wash, or a water wash, or a combination thereof. For example, in one variation, process 100 may further include washing the activated carbon produced with an acid. The acid used to wash the activated carbon produced may be referred to as a “wash acid” or acid wash. In some variations, the wash acid is an aqueous acid. Suitable acids may include, for example, hydrochloric acid.

In other variations, the activated carbon may be washed with an organic wash, an aqueous wash, brine, or a basic wash.

In other embodiments, the activated carbon produced may be dried, either with or without washing the activated carbon as described above. For example, in one variation, the activated carbon produced may be washed, followed by dried. Any suitable methods to dry the activated carbon may be employed.

Activated Carbon Yield

The yield of activated carbon produced may be expressed based on the amount of a resin composite (or furanic resin) used. Thus, in some embodiments, the yield of activated carbon produced (or the “activated carbon yield”) is determined based on the mass of activated carbon divided by mass of the resin composite (or furanic resin).

In some variations, the activated carbon yield, by weight, is at least 5%, at least 10%, at least 15%, at least 20%, at least 25%, at least 30%, at least 35%, at least 40%, at least 45%, at least 50%, at least 55%, or at least 60%; or between 1% and 60%, between 1% and 50%, between 1% and 40%, between 1% and 30%, between 5% and 60%, between 5% and 50%, between 5% and 40%, between 5% and 30%, between 10% and 60%, between 10% and 50%, between 10% and 40%, or between 10% and 30%.

Surface Area Product Efficiency

The methods described herein may also be characterized by the surface area product efficiency, which is calculated as follows: (surface area of the activated carbon) x (activated carbon yield). The surface area product efficiency is expressed as the activated carbon's surface area per gram of resin composite (or furanic resin) used to produce the activated carbon.

In one variation of the methods provided herein, the activated carbon yield, by weight, is at least 5%, and the activated carbon has a surface of at least 2500 m²/g. Thus, in one variation, the surface area product efficiency is at least 125 m²/g of resin composite (or furanic resin) used. In another variation of the methods provided herein, the activated carbon yield, by weight, is at least 25%, and the activated carbon has a surface of at least 1300 m²/g. Thus, in another variation, the surface area product efficiency is at least 325 m²/g of resin composite (or furanic resin) used.

In other variations, the surface area product efficiency of the activated carbon described produced according to the methods described herein is at least 125 m²/g, at least 150 m²/g, at least 175 m²/g, at least 200 m²/g, at least 225 m²/g, at least 250 m²/g, at least 275 m²/g, at least 300 m²/g, at least 325 m²/g, at least 350 m²/g, at least 374 m²/g, at least 400 m²/g, or at least 500 m²/g; or between 125 m²/g and 500 m²/g, between 125 m²/g and 400 m²/g, between 200 m²/g and 350 m²/g, between 300 m²/g and 400 m²/g or between 300 m²/g and 500 m²/g of resin composite (or furanic resin) used to produce the activated carbon.

### Resin Composite (or Furunic Resin)

In some aspects, provided is a resin composite. In some embodiments, the resin composite may be produced according to any of the methods described herein. The resin composite includes various components, including furanic polymer and salt. Thus, in some aspects, provided is a resin composite that includes: a plurality of particles, wherein each particle independently comprises furanic polymer; and salt.

Furanic Polymer

The resin composite includes furanic polymer. At least a portion of the monomers of the furanic polymer has a furanic ring in their structure. The furanic polymer in the resin composite is derived from the feedstock.

For example, without wishing to be bound by any theory, when the feedstock comprises cellulose, the furanic polymer may be formed as a result of one or more possible reactions. Cellulose can convert to (halomethyl)furfural and/or (hydroxymethyl)furfural (e.g., when the feedstock is contacted with the acid and salt as described herein). Further, the (halomethyl)furfural and/or (hydroxymethyl)furfural can undergo degradation. The (halomethyl)furfural and/or (hydroxymethyl)furfural, and their degradation products, may react to produce the furanic polymer.

In another example, without wishing to be bound by any theory, when the feedstock comprises lignocellulose, the furanic polymer may be formed as a result of one or more possible reactions. Lignin can degrade, and hemicellulose and/or cellulose can convert to one or more products such as furfural, (halomethyl)furfural and/or (hydroxymethyl)furfural). Further, the furfural, (halomethyl)furfural and/or (hydroxymethyl)furfural) can undergo degradation. The lignin, furfural, (halomethyl)furfural and/or (hydroxymethyl)furfural, and their degradation products, may react to produce the furanic polymer.

In some variations, the resin composite has at least 80%, at least 85%, at least 90%, or least 95% by weight of furanic polymer. In other variations, the resin composite has up to 60% by weight of furanic polymer. In one variation, the resin composite has between 20% and 60% by weight of furanic polymer.

In some variations, the furanic polymer is cross-linked.

Salt Content

The salt present in the resin composite may come from the feedstock. In some variations, any of the salts used in the methods described herein to produce the resin composite may be used. For example, in some variations, the salt is A^{r+}(X⁻)ᵣ, wherein A^{r+} is a Group I or Group II cation, and X is a halo anion. In certain variations. A^{r+} is Li⁺, Na⁺, K⁺, Rb⁺, Cs⁺, Mg²⁺, Ca²⁺, or Sr²⁺. In one variation, A^{r+} is Li²⁺. In another variation, A^{r+} is Ca²⁺. In yet other variations, X is chloro or bromo. An example of a salt that may be present in the resin composite includes calcium chloride.

The salt present in the resin composite may also come from neutralization, if the isolated resin composite is neutralized, as described herein. In some variations, the salt incorporated in the resin composite may be produced in situ by the neutralizing step discussed herein. For example, CaCl₂—NaCl can be formed in situ by using a NaOH wash, which HC (e.g., that may be present from the synthesis of the resin composite) reacts with the NaOH to form NaCl and H₂O.

In some variations, the resin composite contains between 1% and 25%, between 2% and 20%, or between 2% and 15%, between 2% and 10%, or between 2% and 5% by weight of salt. In one variation, the resin composite contains less than 20% by weight of salt. Any suitable methods or techniques known in the art may be used to determine the overall salt content of the resin composite.

When the resin composite is produced according to the methods described herein (e.g., from a feedstock, an acid and a salt), in some variations, at least a portion of the salt is embedded in the resin composite. In some variations, at least a portion of the salt is incorporated into at least a portion of the particles. In certain variations, a substantial portion of the salt is incorporated into at least a portion of the particles. In other variations, at least 0.01%, at least 0.1%, at least 0.5%, or at least 1% by weight of the salt present in the resin composite is incorporated into at least a portion of the particles. This is in contrast to salt that may be present on the surface of particles or between particles.

In other variations, at least a portion of the salt is present in the interior of at least a portion of the particles. In certain variations, a substantial portion of the salt is present in the interior of at least a portion of the particles. In one variation, at least 0.01%, at least 0.1%, at least 0.5%, or at least 1% by weight of the salt present in the resin composite is present in the interior of the particles. This is once again in contrast to salt that may be present on the surface of particles or between particles.

The amount of salt embedded in the resin composite may be determined by any suitable methods or techniques known in the art. For example, the amount of salt embedded in the resin composite may be determined by a washing protocol to measures the amount of salt that remains in a sample after washing. Using such a washing protocol, any salt that is washed away is considered non-embedded.

In one example, a suitable washing protocol may involve the use of a certain volume of water (e.g., 20-100 equivalents of water related to the resin composite). The water may be added in one or more lots, where the resin composite is suspended in the water for a given amount of time, and then the water is drained away. After the washings, the resin composite can be dried. The dry resin composite can then be submitted for analysis to determine the amount of salt the remains, which reflects the embedded salt content.

Thus, in some variations, provided is resin composite made up of a plurality of particles, wherein each particle independently comprises furanic polymer, and salt, wherein at least a portion of the salt is embedded into at least a portion of the particles, such that when the resin composite is washed with water (e.g., 20 to 100 equivalents of water), at least 0.01%, at least 0.1%, at least 0.5%, or at least 1%, at least 5%, at least 10%, at least 20% by weight of the salt remains in the resin composite after washing.

Oxygen and Carbon Content

Any suitable methods or techniques known in the art may be employed to determine oxygen and carbon content.

In some variations, the resin composite has: (i) an oxygen content between 25% and 35% by weight; or (ii) a carbon content between 45% and 70% by weight, or both (i) and (ii). In other variations, the resin composite has a mass ratio of carbon to oxygen between 1.8:1 and 2.4:1.

In other variations, the resin composite has a homogeneous distribution of oxygen. Other Components

The resin composite may include additional components, including, for example, non-furanic polymers, as well as ash and lignin.

Porosity

Porosity of the resin composite may vary. In some variations of the resin composite, porosity of the resin composite may depend on the feedstock used. For example, resin composite produced from cornstarch may have higher porosity than resin composite produced from empty fruit bunches.

In certain embodiments, the resin composite is microporous, mesoporous and/or macroporous. In some variations, microporous resin composite has an average pore diameter of less than 2 nm. In some variations, mesoporous resin composite has an average pore diameter of between 2 nm and 50 nm. In some variations, macroporous resin composite has an average pore diameter greater than 50 nm.

Morphology

The presence of the salt in the resin composite was unexpectedly observed to maintain the morphology of the resin composite during the activation process.

In some embodiments, the resin composite is made up of spherical particles. In some variations, at least 10%, at least 20%, at least 30%, at least 40%, at least 50%; or between 10% and 20%, between 20% and 30%, between 30% and 40%, or between 40% and 50% of the resin composite is made up of spherical particles. Such spherical particles are made up of furanic polymer (including, for example, cross-linked furanic polymer). Further, salt present in the resin composite may be embedded or incorporated into the spherical particle.

In some embodiments, the resin composite is made up of spherical particles having an average diameter of less than or equal to 500 nm, less than or equal to 400 nm, less than or equal to 300 nm, less than or equal to 200 nm, less than or equal to 100 nm, less than or equal to 90 nm, less than or equal to 80 nm, less than or equal to 70 nm, less than or equal to 60 nm, less than or equal to 50 nm, less than or equal to 40 nm, less than or equal to 30 nm, or less than or equal to 20 nm; or between 20 nm and 500 nm, between 30 nm and 500 nm, between 40 nm and 500 nm, between 50 nm and 500 nm, between 60 nm and 500 nm, between 70 nm and 500 nm, between 80 nm and 500 nm, between 90 nm and 500 nm, between 100 nm and 500 nm, between 200 nm and 500 nm, between 300 nm and 500 nm, or between 400 nm and 500 nm.

The morphology of the resin composite may depend on the feedstock used. A resin composite may, in certain variations, be made up of spherical particles of different sizes. If a combination of feedstocks is used, the resin composite may have spherical particles of different sizes.

For example, in one variation where empty fruit bunches are used as the feedstock, the resin composite includes a plurality of spherical particles having an average diameter between 20 nm and 80 nm. In another variation where corn starch is used, the resin composite includes a plurality of spherical particles having an average diameter between 150 nm and 400 nm. In yet another variation where glucose is used, the resin composite includes a plurality of spherical particles having an average diameter between 100 nm and 400 nm spheres. In yet another variation where wood chips and/or cardboard are used, the resin composite includes a plurality of spherical particles having an average diameter between 30 nm and 60 nm. In yet another variation where southern pine is used, the resin composite includes a plurality of spherical particles having an average diameter between 40 nm and 85 nm.

The presence of a binding material in the feedstock may also affect the particle size in the resin composite. In some variations when the feedstock includes a binding material, the resin composite produced may have an average particle that is smaller than a resin composite produced from a feedstock without a binding material.

In other variations, the resin composite may have a honey-comb or lattice configuration.

Other Properties

In some variations, the resin composite has less than 10%, less than 5%, or less than 1% by weight of solvent. Such solvent may include any solvents used to produce the resin composite.

In other variations, the resin composite has a neutral pH. In one variation, the resin composite has a pH between 4 and 6.

Activated Carbon

The activated carbon provided herein may be characterized by various factors, including, surface area, pore size or pore diameter, and morphology.

Surface Area

In one aspect, the activated carbon described herein has a surface area of at least 1400 m²/g, at least 1500 m²/g, at least 1600 m²/g, at least 1700 m²/g, at least 1800 m²/g, at least 1900 m²/g, at least 2000 m²/g, at least 2100 m²/g, at least 2200 m²/g, at least 2300 m²/g, at least 2400 m²/g, at least 2500 m²/g, at least 2550 m²/g, at least 2600 m²/g, at least 2650 m²/g or at least 2700 m²/g; or between 1400 m²/g and 4000 m²/g, between 2000 m²/g and 4000 m²/g, between 2500 m²/g and 4000 m²/g, between 2500 m²/g and 3000 m²/g, between 2500 m²/g and 2900 m²/g, between 2500 m²/g and 2800 m²/g, between 2500 m²/g and 2750 m²/g, between 2500 m²/g and 2725 m²/g, between 2600 m²/g and 4000 m²/g, between 2600 m²/g and 3000 m²/g, between 2600 m²/g and 2900 m²/g, between 2600 m²/g and 2800 m²/g, between 2600 m²/g and 2750 m²/g, between 2600 m²/g and 2725 m²/g, between 2500 m²/g and 2750 m²/g, between 2600 m²/g and 2750 m²/g, or between 2700 m²/g and 2750 m²/g. In one variation, the activated carbon described herein has a surface area of at least 600 m²/g, at least 700 m²/g, at least 800 m²/g, at least 900 m²/g, at least 1000 m²/g, at least 1100 m²/g, at least 1200 m²/g, or at least 1300 m²/g.

Pore Size

In another aspect, provided is an activated carbon that is microporous, mesoporous and/or macroporous. In some variations, microporous activated carbon has an average pore diameter of less than 2 nm. In some variations, mesoporous activated carbon has an average pore diameter of between 2 nm and 50 nm. In some variations, macroporous activated carbon has an average pore diameter greater than 50 nm.

In yet another aspect, provided is an activated carbon that has a plurality of pores. Each pore has a pore diameter. In some variations, the activated carbon has at least a portion of pore diameters less than 2 nm, less than 3 nm, less than 4 nm, less than 5 nm, less than 6 nm, less than 7 nm, less than 8 nm; or between 1 nm and 50 nm, between 1 nm and 40 nm, between 1 nm and 30 nm, between 1 nm and 25 nm, between 1 nm and 20 nm, between 1 nm and 15 nm, between 1 nm and 10 nm, between 1 nm and 8 nm, between 2 nm and 50 nm, between 2 nm and 40 nm, between 2 nm and 30 nm, between 2 nm and 25 nm, between 2 nm and 20 nm, between 2 nm and 15 nm, between 2 nm and 10 nm, or between 2 nm and 8 nm.

The surface area, pore size and pore diameter of the activated carbon may be measured using any methods or techniques known in the art, such as by gas adsorption. For example, the surface area and pore diameter (or pore size) may be measured by Brunauer-Emmett-Teller (BET) analysis, using adsorbates such as nitrogen (N₂), argon (Ar), benzene (C₆H₆) or carbon tetrachloride (CCl₄). The surface areas and pore diameters provided herein are measured by nitrogen adsorption (i.e., BET-N₂ surface area values). Further, pore size and pore diameter can also be determined by other methods or techniques, such as by scanning electron microscopy (SEM).

Other Properties

In some variations, the activated carbon has a sheet morphology. In other variations, the activated carbon has spherical particles. Any suitable methods known in the art to determine morphology or particle shape of activated carbon may be employed, including, for example, scanning electron microscopy (SEM).

In some embodiments, the activated carbon has a combination of the properties described herein, the same as if each and every combination were individually listed. For example, in one variation, the activated carbon has a surface area of at least 2500 m²/g, and has at least a portion of pore diameters less than 4 nm. In another variation, the activated carbon has a surface area of at least 2500 m²/g, and has at least a portion of pore diameters less than 8 nm. In another variation, the activated carbon has a surface area of between 2500 m²/g and 2725 m²/g, and has at least a portion of pore diameters between 1 nm and 10 nm.

### Uses of the Activated Carbon

The activated carbon provided herein may be used for gas purification, gas scrubbing, water filtration, metal purification, chemical purification and other purification, for gas storage, for use as super capacitor media, or for use as solid catalysts in a variety of chemical reactions.

It should be generally understood that reference to “less than or equal to” or “greater than or equal to” a value or parameter herein includes (and describes) the value or parameter per se. For example, description referring to “less than or equal to x” or “greater than or equal to y” includes description of “x” and “y” per se. In contrast, reference to “less than” or “greater than” a value or parameter herein does not include the value or parameter per se. For example, description referring to “less than x” or “greater than y” excludes description of “x” and “y” per se.

It should also be understood that reference to “between” two values or parameters herein includes (and describes) embodiments that include those two values or parameters per se. For example, description referring to “between x and y” includes description of “x” and “y” per se.

### ENUMERATED EMBODIMENTS

The following enumerated embodiments are representative of some aspects of the invention.

1. A method of producing an activated carbon, comprising:
a) combining a feedstock and an acid to form a reaction mixture, wherein the acid is HX, wherein X is halo;
b) producing a furanic resin from at least a portion of the reaction mixture;
c) isolating the furanic resin;
d) washing the isolated furanic resin;
e) neutralizing the washed furanic resin; and
f) combining the neutralized furanic resin with a base to form an impregnated material; and
g) carbonizing the impregnated material to produce an activated carbon.
   2. The method of embodiment 1, wherein the feedstock and the acid are further combined with a salt to form the reaction mixture, wherein the salt is A^{r+}(X⁻)ᵣ, wherein A^{r+} is a Group I or Group II cation, and X⁻ is an halo anion.
   3. The method of embodiment 1 or 2, wherein the base is an Arrhenius base.
   4. The method of embodiment 1 or 2, wherein the base is a strong base.
   5. The method of embodiment 1 or 2, wherein the base is sodium hydroxide, potassium hydroxide, or calcium hydroxide, or any combinations thereof.
   6. The method of any one of embodiments 1 to 5, wherein the carbonizing of the impregnated material comprises heating the impregnated material to a temperature of at least 800° C.
   7. The method of any one of embodiments 1 to 6, wherein X is chloro or bromo.
   8. The method of any one of embodiments 1 to 7, wherein the acid is added continuously.
   9. The method of any one of embodiments 1 to 8, wherein Ar^{r+} is Li⁺, Na⁺, K⁺, Rb⁺, Cs⁺, Mg²⁺, Ca²⁺, or Sr²⁺.
   10. The method of embodiment 8, wherein A^{r+} is Li⁺.
   11. The method of embodiment 8, wherein A^{r+} is Ca²⁺.
   12. The method of any one of embodiments 1 to 11, wherein the reaction mixture has a [H⁺] less than 12 M.
   13. The method of any one of embodiments 1 to 11, wherein the reaction mixture has a [H⁺] less than or equal to 5 M.
   14. The method of any one of embodiments 1 to 11, wherein the reaction mixture has a [X⁻] of at least 5 M.
   15. The method of any one of embodiments 1 to 14, wherein the feedstock and the acid are further combined with a solvent, wherein the solvent comprises:
(i) one or more alkyl phenyl solvents, one or more heavy alkane solvents, one or more ester solvents, one or more aromatic solvents, one or more silicone oils, or any combinations or mixtures thereof; or
(ii) one or more linear alkyl benzenes; or
(iii) para-xylene, mesitylene, naphthalene, anthracene, toluene, dodecylbenzene, pentylbenzene, hexylbenzene, sulfolane, hexadecane, heptadecane, octadecane, icosane, heneicosane, docosane, tricosane, tetracosane, or any combinations or mixtures thereof; or (iv) one or more phenyl ether solvents.
   16. The method of any one of embodiments 1 to 15, wherein:
(i) the feedstock comprises one or more C6 monosaccharides, disaccharides comprising monomeric units having six carbon atoms, or polysaccharides comprising monomeric units having six carbon atoms; or
(ii) the feedstock is selected from the group consisting of corn stover, corn cob, corn kernel, rice flour, whole cane, beet pulp, beet processing raffinate, empty palm fruit bunches, palm fronds, saw dust, wood pellets, rice hulls, peanut hulls, spent grains, paper sludge, cardboard, old corrugated containers (OCC), old newspaper (ONP), mixed paper, wheat straw, paper mill effluent, newsprint, municipal solid wastes, wood chips, forest thinnings, slash, miscanthus, switchgrass, sorghum, bagasse, manure, wastewater biosolids, green waste, and food or feed processing residues, or any combinations thereof; or
(iii) the feedstock comprises cellulose, glucose, fructose, or any combinations thereof.
   17. The method of any one of embodiments 1 to 16, wherein the acid is produced in situ.
   18. The method of any one of embodiments 2 to 17, wherein the salt is produced in situ.
   19. The method of any one of embodiments 1 to 18, further comprising washing the activated carbon produced with an acid wash.
   20. The method of embodiment 19, wherein the acid wash comprises hydrochloric acid.
   21. The method of any one of embodiments 1 to 20, wherein the activated carbon is produced at a yield of at least 5% by weight.
   22. The method of embodiment 21, wherein the activated carbon has a surface of at least 2500 m²/g.
   23. The method of any one of embodiments 1 to 20, wherein the activated carbon is produced at a yield of at least 25% by weight.
   24. The method of embodiment 23, wherein the activated carbon has a surface of at least 1300 m²/g.
   25. An activated carbon produced according to the method of any one of embodiments 1 to 24.
   26. The activated carbon of embodiment 24, wherein the activated carbon has a surface area of at least 2700 m²/g.
   27. The activated carbon of embodiment 25 or 26, wherein the activated carbon is porous.
   28. The activated carbon of embodiment 25 or 26, wherein the activated carbon is microporous, mesoporous or macroporous, or any combination thereof.
   29. The activated carbon of embodiment 25 or 26, wherein the activated carbon has a plurality of pores, wherein each pore has a pore diameter, and wherein the pore diameter of at least a portion of the pores is less than 8 nm.
   30. The activated carbon of embodiment 29, wherein the pore diameter of at least a portion of the pores is less than 4 nm.
   31. The activated carbon of any one of embodiments 25 to 30, wherein the activated carbon has a sheet morphology.
   32. A method of producing a resin composite, comprising:
   combining a feedstock, an acid and a salt to form a reaction mixture;
   producing a resin composite from at least a portion of the reaction mixture; isolating the resin composite; and
   drying the resin composite,
   wherein the resin composite comprises:
a plurality of particles, wherein each particle independently comprises furanic polymer, and
salt, wherein at least a portion of the salt is incorporated into at least a portion of the particles.
   33. The method of embodiment 32, further comprising washing the isolated resin composite before drying.
   34. The method of embodiment 32, further comprising neutralizing the isolated resin composite before drying.
   35. The method of embodiment 32, further comprising washing the isolated resin composite; and neutralizing the washed resin composite before drying.
   36. The method of embodiment 32, further comprising neutralizing the isolated resin composite; and washing the neutralized resin composite before drying.
   37. The method of any one of embodiments 32 to 36, wherein:
(i) at least 0.01%, at least 0.1%, at least 0.5%, or at least 1% by weight of the salt present in the resin composite is incorporated into the interior of the particles; or
(ii) at least a portion of the salt is embedded into at least a portion of the particles, such that when the resin composite is washed with between 20 to 100 equivalents of water, at least 0.01% by weight of the salt remains in the resin composite after washing, or a combination thereof.
   38. The method of any one of embodiments 33, 35 to 37, wherein the washing is performed using an organic solvent, a brine, or water, or a combination thereof.
   39. The method of embodiment 38, wherein the organic solvent comprises an aromatic solvent.
   40. The method of embodiment 38, wherein the organic solvent comprises toluene.
   41. The method of any one of embodiments 38 to 40, wherein the brine comprises a salt of formula A^{r+}(X⁻)ᵣ, wherein A^{r+} is a Group 1 or Group 11 cation, and X⁻ is a halo anion.
   42. The method of embodiment 41, wherein A^{r+} is Li⁺, Na⁺, K⁺, Rb⁺, Cs⁺, Mg²⁺, Ca²⁺, or Sr²⁺.
   43. The method of embodiment 42, wherein A^{r+} is Li⁺.
   44. The method of embodiment 42, wherein Ar²⁺ is Ca²⁺.
   45. The method of any one of embodiments 41 to 44, wherein X is chloro or bromo.
   46. The method of any one of embodiments 38 to 40, wherein the brine comprises calcium chloride.
   47. The method of any of embodiments 34, 36 to 46, wherein the neutralizing of the isolated resin composite comprises contacting the isolated resin composite with a basic solution.
   48. The method of embodiment 47, wherein the basic solution comprises hydroxide.
   49. The method of embodiment 47, wherein the basic solution comprises potassium hydroxide, or sodium hydroxide, or a combination thereof.
   50. The method of any of embodiments 34, 36 to 49, wherein the neutralized resin composite has a pH between 6 and 8.
   51. The method of any one of embodiments 32 to 50, wherein the drying is performed at a temperature between 100° C. and 250° C.
   52. The method of any one of embodiments 32 to 50, wherein the drying is performed at a temperature between 100° C. and 150° C.
   53. The method of any one of embodiments 32 to 52, wherein the drying comprises removing at least a portion of water present in the isolated resin.
   54. The method of any one of embodiments 32 to 53, wherein:
(i) the dried resin composite has a water absorption capacity of at least 2 g of water/g resin composite;
(ii) resin composite is dried to a point at which the water absorption capacity of the resin composite drops below 0.25 g of water/g resin composite, or a combination thereof.
   55. The method of any one of embodiments 32 to 54, wherein the drying comprises removing at least a portion of water and volatile components present in the isolated resin.
   56. The method of any one of embodiments 32 to 55, wherein the resin composite contains between 2% and 20% by weight of salt.
   57. The method of any one of embodiments 32 to 56, wherein the acid is an Arrhenius acid.
   58. The method of any one of embodiments 32 to 56, wherein the acid is HX, wherein X is halo.
   59. The method of any one of embodiments 32 to 58, wherein the salt is A^{r+}(X⁻)ᵣ, wherein A^{r+} is a Group I or Group II cation, and X⁻ is a halo anion.
   60. The method of embodiment 59, wherein A^{r+} is Li⁺, Na⁺, K⁺, Rb⁺, Cs⁺, Mg²⁺, Ca²⁺, or Sr²⁺.
   61. The method of embodiment 60, wherein A^{r+} is Li⁺.
   62. The method of embodiment 60, wherein A^{r+} is Ca²⁺.
   63. The method of any one of embodiments 32 to 62, wherein X is chloro or bromo.
   64. The method of any one of embodiments 32 to 63, wherein the acid is hydrochloric acid.
   65. The method of any one of embodiments 32 to 60, 62 to 64, wherein the salt is calcium chloride.
   66. The method of any one of embodiments 32 to 65, wherein the reaction mixture has a [H⁺] less than 12 M.
   67. The method of any one of embodiments 32 to 66, wherein the reaction mixture has a [H⁺] less than or equal to 5 M.
   68. The method of any one of embodiments 32 to 67, wherein the reaction mixture has a [X⁻] of at least 5 M.
   69. The method of any one of embodiments 32 to 68, wherein the acid is produced in situ.
   70. The method of any one of embodiments 32 to 69, wherein the acid is added continuously.
   71. The method of any one of embodiments 32 to 70, wherein the salt is produced in situ.
   72. The method of any one of embodiments 32 to 71, wherein the feedstock, acid, and salt are further combined with a solvent.
   73. The method of embodiment 72, wherein the solvent comprises one or more alkyl phenyl solvents, one or more heavy alkane solvents, one or more ester solvents, one or more aromatic solvents, one or more silicone oils, or any combinations or mixtures thereof.
   74. The method of embodiment 72, wherein the solvent comprises one or more linear alkyl benzenes.
   75. The method of embodiment 72, wherein the solvent comprises para-xylene, mesitylene, naphthalene, anthracene, toluene, dodecylbenzene, pentylbenzene, hexylbenzene, sulfolane, hexadecane, heptadecane, octadecane, icosane, heneicosane, docosane, tricosane, tetracosane, or any combinations or mixtures thereof.
   76. The method of embodiment 72, wherein the solvent comprises one or more phenyl ether solvents.
   77. The method of any one of embodiments 32 to 76, wherein the feedstock comprises one or more C6 monosaccharides, disaccharides comprising monomeric units having six carbon atoms, or polysaccharides comprising monomeric units having six carbon atoms.
   78. The method of any one of embodiments 32 to 76, wherein the feedstock is selected from the group consisting of corn stover, corn cob, corn kernel, rice flour, whole cane, beet pulp, beet processing raffinate, empty palm fruit bunches, palm fronds, saw dust, wood pellets, rice hulls, peanut hulls, spent grains, paper sludge, cardboard, old corrugated containers (OCC), old newspaper (ONP), mixed paper, wheat straw, paper mill effluent, newsprint, municipal solid wastes, wood chips, forest thinnings, slash, miscanthus, switchgrass, sorghum, bagasse, manure, wastewater biosolids, green waste, and food or feed processing residues, or any combinations thereof.
   79. The method of any one of embodiments 32 to 76, wherein the feedstock comprises cellulose, glucose, fructose, or any combinations thereof.
   80. The method of any one of embodiments 32 to 79, wherein the furanic polymer is cross-linked.
   81. The method of any one of embodiments 32 to 80, wherein the resin composite has an oxygen content between 25% and 35% by weight.
   82. The method of any one of embodiments 32 to 81, wherein the resin composite has a carbon content between 45% and 70% by weight.
   83. The method of any one of embodiments 32 to 82, wherein the resin composite has a mass ratio of carbon to oxygen between 1.8:1 and 2.4:1.
   84. The method of any one of embodiments 32 to 83, wherein the resin composite has an ash content between 1% and 20% by weight.
   85. The method of embodiment 84, wherein the ash content is between 4% and 15% by weight.
   86. The method of any one of embodiments 32 to 85, wherein the resin composite has a spherical morphology.
   87. The method of any one of embodiments 32 to 86, wherein the resin composite has less than 5% by weight of solvent.
   88. The method of embodiment 87, wherein the resin composite has less than 1% by weight of solvent.
   89. The method of any one of embodiments 32 to 88, wherein the resin composite further comprises non-furanic polymer.
   90. The method of any one of embodiments 32 to 89, wherein the resin composite further comprises ash.
   91. The method of any one of embodiments 32 to 90, wherein the resin composite further comprises lignin.
   92. A resin composite produced according to the method of any one of embodiments 32 to 91.
   93. A resin composite, comprising:
a plurality of particles, wherein each particle independently comprises furanic polymer; and
salt, wherein at least a portion of the salt is incorporated into at least a portion of the particles; and
optionally ash; and
optionally lignin,
wherein the resin is dried.
   94. A resin composite, comprising:
a plurality of particles, wherein each particle independently comprises furanic polymer; and
salt, wherein at least a portion of the salt is present in the interior of at least a portion of the particles; and
optionally ash; and
optionally lignin,
wherein the resin is dried.
   95. The resin composite of embodiment 93 or 94, wherein the resin composite has a water absorption capacity of at least 2 g of water/g resin composite.
   96. The resin composite of embodiment 93 or 94, wherein the resin composite is dried to a point at which the water absorption capacity of the resin composite drops below 0.25 g of water/g resin composite.
   97. The resin composite of any one of embodiments 93 to 96, wherein the salt is A^{r+}(X⁻)ᵣ, wherein A^{r+} is a Group 1 or Group 11 cation, and X⁻ is a halo anion.
   98. The resin composite of embodiment 97, wherein A^{r+} is Li⁺, Na⁺, K⁺, Rb⁺, Cs⁺. Mg²⁺, Ca²⁺, or Sr²⁺.
   99. The resin composite of embodiment 98, wherein A^{r+} is Li⁺.
   100. The resin composite of embodiment 98, wherein A^{r+} is Ca²⁺.
   101. The resin composite of any one of embodiments 97 to 100, wherein X is chloro or bromo.
   102. The resin composite of any one of embodiments 93 to 96, wherein the salt is calcium chloride.
   103. The resin composite of any one of embodiments 93 to 102, wherein the resin composite has between 2% and 20% by weight salt.
   104. The resin composite of any one of embodiments 93 to 103, wherein:
(i) at least 0.01%, at least 0.1%, at least 0.5%, or at least 1% by weight of the salt present in the resin composite is incorporated into the interior of the particles; or
(ii) at least a portion of the salt is embedded into at least a portion of the particles, such that when the resin composite is washed with between 20 to 100 equivalents of water, at least 0.01% by weight of the salt remains in the resin composite after washing,
or a combination thereof.
   105. The resin composite of any one of embodiments 93 to 104, wherein the resin composite has an oxygen content between 25% and 35% by weight.
   106. The resin composite of any one of embodiments 93 to 105, wherein the resin composite has a carbon content between 45% and 70% by weight.
   107. The resin composite of any one of embodiments 93 to 106, wherein the resin composite has a mass ratio of carbon to oxygen between 1.8:1 and 2.4:1.
   108. The resin composite of any one of embodiments 93 to 107, wherein ash is present in the resin composite.
   109. The resin composite of embodiment 108, wherein the resin composite has an ash content between 1% and 20% by weight.
   110. The resin composite of embodiment 109, wherein the ash content is between 4% and 15% by weight.
   111. The resin composite of any one of embodiments 93 to 110, wherein lignin is present in the resin composite.
   112. The resin composite of any one of embodiments 93 to 111, wherein the resin composite has a spherical morphology.
   113. The resin composite of any one of embodiments 93 to 112, wherein the resin composite has less than 5% by weight of solvent.
   114. The resin composite of embodiment 113, wherein the resin composite has less than 1% by weight of solvent.
   115. The resin composite of any one of embodiments 93 to 114, wherein the resin composite has a neutral pH.
   116. The resin composite of any one of embodiments 93 to 114, wherein the resin composite has a pH of between 4 and 6.
   117. The resin composite of any one of embodiments 93 to 116, wherein the furanic polymer is cross-linked.
   118. The resin composite of any one of embodiments 93 to 117, wherein the resin composite further comprises non-furanic polymer.
   119. A method of producing activated carbon, comprising activating a resin composite of any one of embodiments 92 to 118 to produce the activated carbon.
   120. A method of producing activated carbon, comprising:
contacting a resin composite of any one of embodiments 92 to 120 with an activating agent to form an impregnated material; and
heating the impregnated material to produce the activated carbon.
   121. The method of embodiment 120, wherein the impregnated material is heated to a temperature of at least 450° C.
   122. The method of embodiment 120, wherein the impregnated material is heated to a temperature of at least 800° C.
   123. The method of embodiment 120, wherein the impregnated material is heated to a temperature between 450° C. and 850° C.
   124. The method of any one of embodiments 120 to 123, wherein the heating of the impregnated material carbonizes the impregnated material.
   125. The method of any one of embodiments 120 to 124, further comprising drying the impregnated material prior to heating.
   126. The method of any one of embodiments 120 to 125, wherein the resin composite to activating agent ratio is between 0.5:1 and 5:1.
   127. The method of any one of embodiments 120 to 125, wherein the resin composite to activating agent ratio is less than 1:2.
   128. The method of any one of embodiments 120 to 127, wherein the activating agent is a base.
   129. The method of embodiment 128, wherein the base is an Arrhenius base.
   130. The method of embodiment 128, wherein the base is sodium hydroxide, potassium hydroxide, or calcium hydroxide, or any combinations thereof.
   131. The method of any one of embodiments 120 to 127, wherein the activating agent is an acid.
   132. The method of embodiment 131, wherein the activating agent is phosphoric acid or sulfuric acid.
   133. The method of any one of embodiments 120 to 127, wherein the activating agent comprises a metal chloride.
   134. The method of any one of embodiments 120 to 127, wherein the activating agent comprises calcium chloride, or zinc chloride, or any combinations thereof.
   135. The method of any one of embodiments 120 to 127, wherein the activating agent comprises urea.
   136. The method of any one of embodiments 120 to 127, wherein the activating agent comprises zinc chloride and urea.
   137. The method of any one of embodiments 120 to 136, further comprising washing the activated carbon produced with an acid wash, or a water wash, or a combination thereof.
   138. The method of embodiment 137, wherein the acid wash comprises hydrochloric acid.
   139. The method of embodiment 137 or 138, further comprising drying the washed activated carbon.
   140. An activated carbon produced according to a method of any one of embodiments 119 to 139.
   141. The activated carbon of embodiment 140, wherein the activated carbon has a surface of at least 2500 m²/g.
   142. The activated carbon of embodiment 140, wherein the activated carbon has a surface of at least 1300 m²/g.
   143. The activated carbon of embodiment 140, wherein the activated carbon has a surface area of at least 2700 m²/g.
   144. The activated carbon of any one of embodiments 140 to 143, wherein the activated carbon is porous.
   145. The activated carbon of any one of embodiments 140 to 144, wherein the activated carbon is microporous, mesoporous or macroporous, or any combination thereof.
   146. The activated carbon of any one of embodiments 140 to 144, wherein the activated carbon has a plurality of pores, wherein each pore has a pore diameter, and wherein the pore diameter of at least a portion of the pores is less than 8 nm.
   147. The activated carbon of embodiment 146, wherein the pore diameter of at least a portion of the pores is less than 4 nm.

### EXAMPLES

The following Examples are merely illustrative and are not meant to limit any aspects of the present disclosure in any way.

### Example 1

### Synthesis of A Furanic Resin

This example demonstrates the synthesis of a furanic resin from glucose, hydrochloric acid, and calcium chloride. It should be understood that the furanic resin is also generally referred to herein as a resin composite.

A concentrated calcium chloride solution was prepared by diluting 32.78 g of anhydrous calcium chloride to 50 mL in deionized water. The resulting solution was allowed to stir for hours allowing all of the heat to dissipate from the heat of solvation and water was added to make up for any that had evaporated during the mixing time.

An aqueous solution was prepared by adding concentrated hydrochloric acid (9 mL, 109.4 mmol Cl⁻) to the calcium chloride solution prepared above (41 ml, 549.4 mmol Cl⁻) for a total of 50 mL of aqueous solution (658.8 mmol Cl, 13.18 M Cl⁻). A 40 mL sample of that aqueous solution was then poured into a 500 mL round bottomed flask, and glucose (4.0117 g, 22.27 mmol) was then added and allowed to dissolve into the aqueous solution at room temperature with gentle mixing. Toluene (80 mL) was then added and the reaction vessel was sealed. The vessel was then lowered into a 150° C. oil bath and allowed to stir for 16 minutes. The reaction mixture was then removed from heat and cooled quickly using an ice water bath. The reaction mixture was then filtered to isolate the furanic resin, and the furanic resin was then washed with toluene (200 mL).

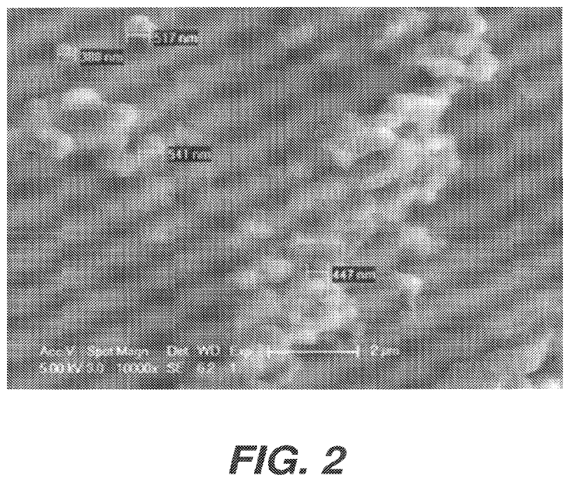

Scanning electron microscopy (SEM) may be used to analyze the furanic resin produced. For example, FIG. 2 depicts an exemplary image of a furanic resin produced using a procedure similar to the one described in this example.

### Example 2

### Converting Furanic Resin to Activated Carbon

This example demonstrates the synthesis of activated carbon from a furanic resin.

A furanic resin was produced and isolated using a procedure similar to the one described in Example 1 above. The furanic resin was then washed with a sodium hydroxide solution until neutralized, and subsequently washed with water. The resulting material was then dried at 100° C.

The dried material was impregnated with an aqueous solution of potassium hydroxide (mass ratio furanic resin:KOH=1:1, 1 g KOH/5 mL water). The mixture was stirred overnight at 60° C. and then dried at 100° C. overnight. The impregnated material was then placed in a ceramic crucible, heated to 850° C. under nitrogen flow with a heating rate of 6.5° C. min⁻¹ and held at the elevated temperature for 2 hours. The crude product was then washed with 5 M hydrochloric acid and water, and dried overnight under vacuum at 40° C.

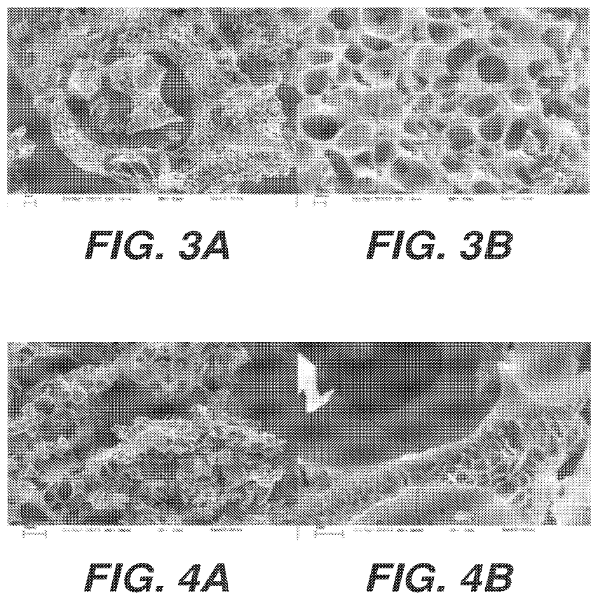

The resulting product was analyzed by scanning electron microscopy (SEM), X-ray diffraction, combustion elemental analysis and nitrogen adsorption. The SEM images are provided in FIG. 3A and FIG. 3B (zoomed in portion of the image in FIG. 3A) The SEM images revealed a homogeneous, porous structure with macropores and mesopores. The nitrogen adsorption measurements revealed the presence of micropores, and that the main part of the surface area originated from micropores. Based on the nitrogen adsorption measurements, the resulting product was observed to have (i) at least a portion of pores with a diameter less than 4 nm, and (ii) a BET surface area of 1470 m² g⁻¹.

Further, the combustion elemental analysis showed that the resulting product had:
C [%]=86.8
H [%]=2.3
N [%]=0.2
S [%]=0.5
Σ [%]=89.8

The yield of the product obtained, relative to the mass of the furanic resin used, was 29.1% for this example. The surface area product efficiency, based on the surface area and yield observed in this example, was 428 m² g⁻¹ of furanic resin.

Thus, based on the data summarized above, the resulting product was confirmed to be an activated carbon. Additionally, when compared to the SEM image of the furanic resin used (FIG. 2), the overall structure and architecture of the resulting product was observed to have been changed in comparison to the structure and architecture of the furanic resin used.

### Example 3

### Converting Furanic Resin to Activated Carbon

This example demonstrates the synthesis of activated carbon from a furanic resin.

A furanic resin was produced and isolated using a procedural similar to the one described in Example 1 above. The furanic resin was then washed with a sodium hydroxide solution until neutralized, and subsequently washed with water. The resulting material was then dried at 100° C.

The dried material was impregnated with an aqueous solution of potassium hydroxide (mass ratio furanic resin:KOH=1:2, 2 g KOH/5 mL water). The mixture was stirred overnight at 60° C. and then dried at 100° C. overnight. The impregnated material was then placed in a ceramic crucible, heated to 850° C. under nitrogen flow with a heating rate of 6.5° C. min⁻¹ and held at the elevated temperature for 2 hours. The crude product was then washed with 5 M hydrochloric acid and water, and dried overnight under vacuum at 40° C.

The resulting product was analyzed by scanning electron microscopy (SEM), X-ray diffraction, combustion elemental analysis and nitrogen adsorption. The SEM images are provided in FIG. 4A and FIG. 4B (zoomed in portion of the image in FIG. 4A) The SEM images revealed that the resulting product had a sheet-like morphology, as well as a porous structure with macropores and mesopores. Based on the nitrogen adsorption measurements, mesopores were also observed, and the resulting product was observed to have (i) a t least a portion of the pores had a diameter of less than 8 nm, and (ii) a surface area of 2714 m² g⁻¹.

Further, the combustion elemental analysis showed that the resulting product had:

C [%]=83.3

H [%]=1.48

N [%]=0.3

S [%]=0.6

Σ[%]=85.6

The yield of the product obtained, relative to the mass of the furanic resin used, was 5.3% for this example. The surface area product efficiency, based on the surface area and yield observed in this example, was 144 m² g⁻¹ of furanic resin.

Thus, based on the data summarized above, the resulting product was confirmed to be an activated carbon. Additionally, when compared to the SEM image of the furanic resin used (FIG. 2), the overall structure and architecture of the resulting product was observed to have been changed in comparison to the structure and architecture of the furanic resin used.

### Example 4A

### Determination of Ash Content in Resin Composite Sample

In this example, the ash content of a resin composite sample was determined, and compared to the ash content of a commercially available corn starch sample.

Materials: The resin composite sample was produced from empty fruit bunches (EFB) according to the protocol set forth in Example 1 above. The results for this EFB resin composite sample was compared to the ash content of commercially available corn starch, as a control.

General protocol: An aqueous slurry containing 4.0 wt. % empty fruit bunches (EFB), hydrochloric acid and calcium chloride was mixed together with toluene at a 1:1 ratio and reacted in a continuous stirred tank reactor (CSTR) at 105° C. with a liquid hourly space velocity of 1.25 to 2.5. The sample was burned in a furnace at about 600° C. to constant mass. The sample was placed into a saggar and put in the furnace with a ramp rate of 10° C. min⁻¹ up to 600° C. for 12-24 hours (to achieve constant mass). The sample was heated for three cycles to confirm constant mass.

Results: The EFB resin composite sample had an ash content of 7.3 wt. %. The corn starch sample had an ash content of 0.0616 wt. %.

### Example 4B

### Determination of Ash Content in Resin Composite Sample

In this example, the ash content of a resin composite sample was determined.

The resin composite as produced from empty fruit bunches, according to the procedure set forth in Example 1. The resin composite was calcined in air at 600° C. for 48 hours. The ash content for this sample was determined according to the procedure set forth in Example 4A above. The sample had an ash content of 7.3 wt. %.

The ash obtained from the calcined resin composite was analyzed using energy dispersive X-ray spectroscopy (EDX). Both silica (SiO₂) and salt particles were observed in the ash. The dominant morphology observed in the ash was made up of silica with 10-20-micron spiked globules. A second thin flake-like morphology was also observed interspersed on and between the large silica globules. These flakes were primarily made up of potassium chloride. In both cases, minor quantities of metals was observed. Such metals included potassium, calcium, aluminum, sodium and nickel, as well as residual oxygen, which may be in the form of metal oxides. The silica as well as trace amounts of alumina may have originated in the lignocellulosic biomass. The EDX analysis of the sample is summarized in Table 1 below.

TABLE 1

| | |
|---|---|
| Silica Ash | Salt Ash |

| Element | Wt. % | At. % | Wt. % | At. % |
|---|---|---|---|---|
| O K | 43.33 | 60.24 | 13.64 | 26.71 |
| Ni L | 0.00 | 0.00 | 2.37 | 1.27 |
| Na K | 0.00 | 0.00 | 0.98 | 1.33 |
| Al K | 0.44 | 0.36 | 0.88 | 1.03 |
| Si K | 32.07 | 25.40 | 4.56 | 5.09 |
| S K | 1.81 | 1.26 | 0.00 | 0.00 |
| Cl K | 2.97 | 1.86 | 31.79 | 28.09 |
| K K | 8.23 | 4.68 | 35.96 | 28.81 |
| Ca K | 11.15 | 6.19 | 9.82 | 7.67 |

### Example 5

### Production of Activated Carbon from a Resin Composite Using Potassium Hydroxide as Activating Agent

This example demonstrates the synthesis of activated carbon from a resin composite via chemical activation by potassium hydroxide (KOH).

A resin composite produced from glucose was produced and isolated using a procedural similar to the one described in Example 1 above. The resin composite was then washed with a sodium hydroxide solution until neutralized, and subsequently washed with water. The resulting material was then dried at 100° C.

The dried resin composite was impregnated with an aqueous solution of potassium hydroxide (KOH) (mass ratio resin composite:KOH=1:2). The mixture was stirred for 12 hours at 60° C. and then heated to 110° C. and dried to constant mass. The impregnated material was then placed in a ceramic crucible and heated to 850° C. under nitrogen flow with a heating rate of 7° C. min⁻¹ and held at the elevated temperature for 2 hours. The crude product (activated carbon) was washed with 5 M hydrochloric acid and water, and then dried overnight at 85° C. The dry mass yield of activated carbon was up to 25 wt. % based on the initial amount of resin composite and contained a 5.9 wt. % ash content.

A sample of the resulting activated carbon was analyzed by scanning electron microscopy (SEM). The SEM images showed a sponge-like morphology with large macropores of about 3 microns in diameter.

Nitrogen adsorption measurements were also obtained to determine the surface area and pore size of the resulting product. The surface area was observed to be between 1660 to 2714 m² g⁻¹. Quenched solid density functional theory (QSDFT) analysis revealed 1 to 3 nm pores.

### Example 6

### Production of Activated Carbon from a Resin Composite Using Zinc Chloride and Urea as Activating Agents

This example demonstrates the synthesis of activated carbon from a resin composite via chemical activation by zinc chloride (ZnCl₂) and urea (CH₄N₂O).

A resin composite produced from empty fruit bunches was produced and isolated using a procedural similar to the one described in Example 1 above. The resin composite was then washed with a sodium hydroxide solution until neutralized, and subsequently washed with water. The resulting material was then dried at 100° C.

The dried resin composite was mixed with dry cornstarch (CS) at a ratio of 25:4 resin composite:CS. An aqueous solution of ZnCl₂, urea and water at a ratio of 40:11:30 ZnCl₂:CH₄N₂O:H₂O was prepared and added to the powder sample at room temperature so that the final ratio of reactants was 25:40:11:4:30 resin composite:ZnCl₂:CH₄N₂O:CS:H₂O. The paste was stirred by hand until the powder was homogenously wetted. The paste was then heated to 110° C. for and dried to constant mass. The resulting hard cake was ground and heated to 180° C. under nitrogen from 1 hour. The material was then heated at 7° C. min⁻¹ to 850° C. and held isothermally for 2 hours. The resulting crude product (activated carbon) was washed for four hours with 1 M hydrochloric acid (HCl) at room temperature. The material was washed with boiling water until the pH of the wash effluent was above pH 4, and then dried overnight at 85° C. The dry mass yield of activated carbon was up to 58 wt. % based on the initial amount of resin composite and contained a 6.8 wt. % ash content.

The activated carbon was found to have an iodine adsorption number of 883 mg g⁻¹. The surface area measured by nitrogen physisorption was observed to be 1061 m² g⁻¹.

### Example 7

### Production of Activated Carbon from a Resin Composite using Phosphoric Acid as Activating Agent

This example demonstrates the synthesis of activated carbon from resin composite via chemical activation by phosphoric acid (H₃PO₄).

A resin composite produced from empty fruit bunches was produced and isolated using a procedural similar to the one described in Example 1 above. The resin composite was then washed with a sodium hydroxide solution until neutralized, and subsequently washed with water. The resulting material was then dried at 100° C.

The dried resin composite was impregnated with concentrated H₃PO₄ (85 wt. %) at a ratio of 2:3 resin composite:H₃PO₄ at 85° C. for 2 hours. The resulting paste was heated under nitrogen at a rate of 3° C. min⁻¹ to 450° C. and held isothermally for 4 hours. The resulting crude product (activated carbon) was washed with boiling water until the wash effluent was above pH 4. The resulting material was dried overnight at 85° C. The dry mass yield of activated carbon was up to 60 wt % based on the initial amount of resin composite.

The material was found to have an iodine adsorption number of 615 mg g⁻¹ and the BET surface area as measured by nitrogen adsorption is 1264 m² g⁻¹.

### Example 8

### Production of Activated Carbon from a Resin Composite Using Calcium Chloride

This example demonstrates the synthesis of activated carbon from unwashed and unneutralized resin composite via washing and chemical activation with calcium chloride.

An unwashed and unneutralized resin composite was produced from reaction of southern pine using an aqueous solution of 6.7 M calcium chloride and 4 M hydrochloric acid. The resulting resin composite was washed with toluene until all residual chloromethylfurfural (CMF) was removed. Next, the toluene washed-resin composite was mixed with a brine of 5 M CaCl₂. The resulting slurry was filtered until a semi-dry filter cake remained. This cake was again mixed with 5 M CaCl₂ brine. The washing was repeated until the pH of the filtered CaCl₂ was above pH 4. The CaCl₂-impregnated material was then dried to constant mass at 110° C. The ratio of dry resin composite to CaCl₂ was between 1:1 and 1:2 resin composite:CaCl₂.

The dried resin composite impregnated with CaCl₂ was dried at 110° C. Next, the impregnated material was heated under nitrogen at a rate of 5° C. min⁻¹ to 850° C. and held isothermally for 2 hours. The resulting crude product (activated carbon) was washed with boiling water until the wash effluent was above pH 4, and was then dried overnight at 85° C. The dry mass yield of activated carbon was up to 41 wt. % based on the initial amount of resin composite.

The surface area measured by nitrogen physisorption was observed to be up to 381 m² 1.

### Example 9

### Production of Activated Carbon from a Resin Composite Using Calcium Chloride and Urea

This example demonstrates the synthesis of activated carbon from a resin composite via chemical activation with CaCl₂.

A resin composite produced from empty fruit bunches was produced and isolated using a procedural similar to the one described in Example 1 above. The resin composite was then washed with a sodium hydroxide solution until neutralized, and subsequently washed with water. The resulting material was then dried at 100° C.

The dried resin composite was impregnated with an aqueous solution of CaCl₂ and urea containing a ratio of 49.7:30:122 CaCl₂:CH₄N₂O:H₂O. The resin composite was impregnated with this solution at a total ratio 30:49.7:30:122 resin composite:CaCl₂:CH₄N₂O:H₂O. The paste was stirred by and until the powder was homogenously wetted. The paste was then heated to 110° C. for 24 hours and dried to constant mass. The resulting hard cake was ground and heated under nitrogen at a rate of 5° C. min⁻¹ to 850° C. and held isothermally for 2 hours. The resulting crude product (activated carbon) was washed with boiling water until the wash effluent was above pH 4, and was then dried overnight at 85° C. The dry mass yield of activated carbon was up to 43 wt. % based on the initial amount of resin composite.

The material was found to have an iodine adsorption of 111 mg g⁻¹.

1. A method of producing a resin composite, comprising:
combining a feedstock, an acid and a salt to form a reaction mixture;
producing a resin composite from at least a portion of the reaction mixture;
isolating the resin composite; and
drying the resin composite,
wherein the resin composite comprises:
a plurality of particles, wherein each particle independently comprises furanic polymer, and
salt, wherein at least a portion of the salt is incorporated into at least a portion of the particles.

2-5. (canceled)

6. The method of claim 1,
wherein the drying is performed at a temperature between 100° C. and 250° C.

7. The method of claim 1, wherein:
(i) the dried resin composite has a water absorption capacity of at least 2 g of water/g resin composite;
(ii) the resin composite is dried to a point at which the water absorption capacity of the resin composite drops below 0.25 g of water/g resin composite,
or a combination thereof.

8. The method of claim 1, wherein the resin composite contains between 2% and 20% by weight of salt.

9. The method of claim 1, wherein at least 0.01%, at least 0.1%, at least 0.5%, or at least 1% by weight of the salt present in the resin composite is incorporated into the interior of the particles.

10. The method of claim 1, wherein at least a portion of the salt is embedded into at least a portion of the particles, such that when the resin composite is washed with between 20 to 100 equivalents of water, at least 0.01% by weight of the salt remains in the resin composite after washing.

11. The method of claim 1, wherein the acid is:
(i) HX, wherein X is halo; or
(ii) hydrochloric acid.

12. The method of claim 1, wherein the salt is:
(i) A^{r+}(X⁻)ᵣ, wherein A^{r+} is a Group I or Group II cation, and X⁻ is a halo anion; or
(ii) calcium chloride.

13. The method of claim 1, wherein the furanic polymer is cross-linked.

14. The method of claim 1, wherein the resin composite has:
(i) an oxygen content between 25% and 35% by weight;
(ii) a carbon content between 45% and 70% by weight;
(iii) a mass ratio of carbon to oxygen between 1.8:1 and 2.4:1;
(iv) an ash content between 1% and 20% by weight;
(v) less than 5% by weight of solvent; or
(vi) a spherical morphology,
or any combinations of (i)-(vi).

15. The method of claim 1, wherein the resin composite further comprises non-furanic polymer, ash, or lignin, or any combinations thereof.

16. A resin composite produced according to the method of claim 1.

17. A resin composite, comprising:
a plurality of particles, wherein each particle independently comprises furanic polymer; and
salt, wherein at least a portion of the salt is incorporated into at least a portion of the particles; and
optionally ash; and
optionally lignin,
wherein the resin is dried.

18. (canceled)

19. (canceled)

20. The resin composite of claim 17, wherein the salt is A^{r+}(X⁻)ᵣ, wherein A^{r+} is a Group I or Group II cation, and X⁻ is a halo anion.

21. The resin composite of claim 17, wherein the salt is calcium chloride.

22. The resin composite of claim 17, wherein the resin composite has between 2% and 20% by weight salt.

23-27. (canceled)

28. A method of producing activated carbon, comprising
activating a resin composite of claim 16 to produce the activated carbon.

29. A method of producing activated carbon, comprising:
contacting a resin composite of claim 16 with an activating agent to form an impregnated material; and
heating the impregnated material to produce the activated carbon.

30-34. (canceled)

35. An activated carbon produced according to a method of claim 28.

36-38. (canceled)

39. An activated carbon, wherein the activated carbon has a surface area of at least 600 m²/g, and wherein the activated carbon is microporous, mesoporous, or macroporous.
